(19) United States
(12) Patent Application Publication
(10) Pub. No.: US 2026/0086054 A1
(43) Pub. Date: Mar. 26, 2026

(54) Method and System to Determine Heat Release Rate and Total Heat Release of Aircraft Cabin Materials using Auto-Calibration

(71) Applicant: The United States of America, as represented by the Administrator of the Federal Aviation Administra, Jamaica, NY (US)

(72) Inventor: Michael Burns, Cape May Court House, NJ (US)

(73) Assignee: The United States of America, as represented by the Administrator of the Federal Aviation Administra, Jamaica, NY (US)

(21) Appl. No.: 19/337,960

(22) Filed: Sep. 24, 2025

Related U.S. Application Data
(60) Provisional application No. 63/698,197, filed on Sep. 24, 2024.

(51) Int. Cl. G01N 25/38

(52) U.S. Cl. CPC G01N 25/38

(57) ABSTRACT

A system for determining the heat release rate of a sample material is provided that includes a computing device coupled to a heat release rate apparatus, the heat release rate apparatus includes an environmental chamber with heating elements that provide heat flux directed at the sample material, an upper pilot burner for burning off gasses and a lower pilot burner for igniting the sample material. The apparatus further includes a pyramidal section coupled to the environmental chamber and a plurality of temperature sensors located at the outlet opening of the pyramidal section for measuring outlet gas temperature and a temperature sensor for measuring inlet air temperature, where the computing device receives temperature readings from the plurality of sensors and determines the heat release rate (HRR) of the sample material based on absolute temperature differential of a combustion stream through the apparatus.

### RELATED APPLICATION

This application claims the benefit of U.S. (Provisional) Application No. 63/698,197, entitled “Method and System to Determine Heat Release Rate and Total Heat Release of Aircraft Cabin Materials using Auto-Calibration (AutoCal)”, filed Sep. 24, 2024, which is hereby incorporated herein by reference.

### BACKGROUND OF THE INVENTION

The Present application relates to testing equipment and more specifically equipment for calculating the heat release rate (HRR) of materials.

The Federal Aviation Administration (FAA) requires large surface area materials intended for use in commercial passenger aircraft, such as ceilings, stow bins, and sidewalls, to be tested using the Ohio State University (OSU) heat release rate test. The requirements for such materials are set forth in 14 CFR § 25 and § 121. Multi-laboratory studies that tested the same material for heat release rate (HRR), using the current process, however, often achieved varying results, indicating that HRR test result reproducibility can be improved. Many factors can contribute to this poor agreement between HRR test results achieved by different laboratories, including discrepancies in the burdensome calibration procedures used to set up the HRR test equipment. Accordingly, there is a need for improved methods and systems for determining the HRR of materials that are not prone to the limitations of prior systems.

### SUMMARY OF THE INVENTION

In one aspect, a system for determining the heat release rate of a sample material is provided that includes a computing device coupled to a heat release rate apparatus, the heat release rate apparatus including: (1) an environmental chamber having a tubular structure with openings at a top end and a bottom end thereof, the environmental chamber including a plurality of heating elements that provide heat flux directed at the sample material, and an upper pilot burner and a lower pilot burner, where the lower pilot burner initiates combustion of the sample material and the upper burner ignites off-gassing products during testing of the sample material; (2) a holding chamber having a tubular structure with openings laterally at a distal end and a proximal end thereof, the holding chamber tangentially coupled to the environmental chamber with a radiation door assembly between the environmental chamber and the holding chamber; (3) a pyramidal section having openings at a top end and a bottom end thereof, the bottom end of the pyramidal section coupled to the top end of the environmental chamber; and (4) a plurality of sensors include a set of first temperature sensors located at the outlet opening of the pyramidal section for measuring exit gas temperature and a second temperature sensor for measuring inlet air temperature, where the computing device is configured to receive temperature readings from the plurality of sensors, including the exit gas temperature and the inlet air temperature, and to determine the heat release rate (HRR) of the sample material based on absolute temperature differential of a combustion stream through the apparatus.

In one embodiment, the pyramidal section has a single plenum structure without supplemental cooling.

In one embodiment, the set of first temperature sensors include a plurality of thermocouples configured to continuously monitor exit gas temperature.

In one embodiment, the plurality of thermocouples include at least five thermocouples with ends located below the outlet opening of the pyramidal section, including a first thermocouple with an end placed at a geometric center of the outlet opening, and four other thermocouples with ends placed at the outlet opening radially from the first thermocouple end.

In one embodiment, ends of the first and the four other thermocouples are placed along a single horizontal plane within the outlet opening of the pyramidal section.

In one embodiment, the first and the four other thermocouples each have an outer portion that extends horizontally and is parallel to the outer portion of the other thermocouples.

In one embodiment, the first and the four other thermocouples include a first pair and second pair of thermocouples that each have a thermocouple that is a mirror image of the other thermocouple.

In one embodiment, the absolute temperature differential of the combustion stream through the apparatus is determined based on an average of inputs from the first and the four other thermocouples at the outlet temperature determined, and inputs from the second temperature sensor.

In one embodiment, the apparatus includes a mass airflow controller that controls airflow through the apparatus to 20.0±0.4 SCFM at 22.5±1.4° C., the mass airflow controller located at an inlet of the environmental chamber.

In one embodiment, the apparatus includes first and second stage distribution plates each having a plurality of holes therein to provide laminar flow within at least a portion of the environmental chamber.

In one embodiment, the apparatus includes a specimen rod configured to receive the sample material at a distal end of the specimen rod, the specimen rod slidingly attached to a holding chamber door hingedly coupled to the holding chamber at the proximal opening of the holding chamber, the specimen rod therewith configured to insert the sample specimen into the holding chamber in an arcuate trajectory and then into the environmental chamber by sliding the specimen rod distally through the radiation doors toward the environmental chamber.

In one embodiment, the heating elements provide heat flux directed at the sample material center at 3.65±0.05 W/cm².

In one embodiment, the computing device determines HRR based on a baseline temperature differential before the sample material is inserted into the environmental chamber, and the absolute temperature differential after the sample material is inserted into the environmental chamber.

In one embodiment, the computing device determines HRR based on a first calibration factor (Kh₁) determined by sensible heat rise of the air stream though the apparatus, and a second calibration factor Kh₂ calculated using known heat content of methane gas and differential temperature rise ΔT(t) of the air stream due to material combustion.

Additional aspects of the present invention will be apparent in view of the description which follows.

### BRIEF DESCRIPTION OF THE FIGURES

In order that features of the present disclosure can be understood in detail, a more particular description may be had by reference to aspects and features, some of which are illustrated in the appended drawings. It is to be noted, however, that the drawings illustrate only certain typical aspects and features of this disclosure and are therefore not to be considered limiting of its scope, and that the description may allow for other equally effective aspects and features. The same reference numbers in different drawings identify the same or similar elements.

FIG. 1 is a diagram depicting a Heat Transfer Model for the HR2 Apparatus.

FIGS. 2a-2b are plots of Methane Calibrations of Deatak and Marlin machines.

FIGS. 3a-3c are perspective views of a heat release rate apparatus according to one embodiment of the devices disclosed herein.

FIGS. 4a-4q are perspective views of the pyramidal section and hot zone thermocouples according to one embodiment of the devices disclosed herein.

FIGS. 5a-b are side and front views of the lower pilot-flame profile (shown with sample holder) according to one embodiment of the devices disclosed herein.

FIGS. 6a-6h are images of the recommended specimen foil wrapping.

FIG. 7 is an exploded view of the specimen holder according to one embodiment of the devices disclosed herein.

FIG. 8 is a side view of the specimen holder in situ in the environmental chamber with the lower pilot burner according to one embodiment of the devices disclosed herein.

FIG. 9 is an image of the upper pilot burner HSI rod and bracket installation

FIG. 10 is a plot of Dynamic Kₕ During a Test (Kₕ=Kₕ₁+Kₕ₂)

FIGS. 11-20 are plots of test Materials #1-10

FIG. 21 is a block diagram of a heat release detection data acquisition system according to one embodiment of the systems disclosed herein.

### DETAILED DESCRIPTION

The present application provides novel methods and systems for determining heat release rate (HRR) of material or parts, particularly those intended to be used for interior of vehicles, such as aircraft, using an HRR test apparatus. It is understood that the specific “test method(s)”, and “test apparatus” or “test equipment” discussed herein are exemplary and therefore not limiting.

To improve the reliability of HRR test results, a detailed revision of the HRR test equipment was conducted to better standardize test equipment components and procedures, including test equipment calibration. Major changes to the HRR test equipment and procedures were developed, including, inter alia, replacing a dual airflow design of prior test equipment (i.e., a design which uses cooling air flow controlled by an air manifold at the pyramidal section) with one that uses (an uncooled) single flow through-the-unit design determined using mass flow controllers, as discussed in greater detail below. Additionally, a novel calibration process was developed that replaces the previous labor- and time-intensive process with a process that allows calibration to be completed in a fraction of the time that it takes to calibrate HRR test equipment. The novel calibration approach of the present application may even eliminate the need for calibration altogether, thereby reducing operational cost and time for facilities conducting HRR tests.

Generally, burning aircraft material of mass (m) in, for example, the second-generation heat release rate apparatus (HR2), releases the heat of combustion (Q) into the air stream of the forced convective environment of the HR2, which raises the combustion stream temperature. An empirical formula was developed that exactly reproduced the HRR history of a material of interest, which uses the absolute temperature rise of the combustion stream through the apparatus, rather than the calibrated temperature rise under the current regulatory HRR testing scheme. The calibrated temperature rise is obtained by determining the difference in the outlet temperature (Tₒᵤₜ) of the combustion stream relative to a pre-heat (baseline) temperature, which is measured at the inlet while burning methane at a calibrated flow. Using the automatic (empirical) calculation of HRR of a material, in accordance with the present disclosure, instead of one based on the calibration temperature may obviate the need for the methane calibration procedure altogether.

### 1.0 Scope of the Disclosure

The method or methods disclosed herein (generally also referred to herein as the “test method”) describes the process for determining the heat release rates (HRR) of materials and products (or parts thereof) when exposed to radiant heat using the exemplary test apparatus, specimen configurations, and calibration procedures. The test method is intended to measure and describe the properties of materials, products, or assemblies, particularly regarding HRR, in response to the application of a level of heat and flame under controlled laboratory conditions. The test method was not intended to describe or appraise the propensity of a given material to pose a fire hazard under actual fire conditions, although the results of HRR testing may be used as elements of a fire risk assessment, which accounts for all of the factors relevant for an assessment of the fire hazard of a particular end use.

With reference to the accompanying drawings, in the preferred embodiment, HRR is measured for the duration of the test from the moment the specimen is injected into the controlled environmental chamber 304 of the test apparatus 300 and encompasses the period of ignition and progressive flame involvement of the material.

### 2.0 Definitions

### 2.1 Heat Release Rate

Heat release rate or HRR is generally a measure of the rate at which heat energy is evolved by a material when burned. HRR is expressed in terms of power per unit area (kilowatts per square meter, kW/m²). The maximum HRR occurs when the material is burning most intensely. The peak heat release rate that occurs during a 5-minute test is typically reported.

### 2.2 Total Heat Release

Total heat release is a measure of the amount of total heat energy evolved by a material when burned. It is expressed as energy per unit area (kilowatt minutes per square meter, kW·min/m²). The total amount of heat energy released during the first 2 minutes of testing is typically preferably reported.

### 2.3 Heat Flux Density

Heat flux density is the intensity of the thermal environment to which the specimen is exposed when burned. In the preferred embodiment of the test method, the total heat flux density is set and/or controlled to about 3.65 W/cm² (3.21 BTU/ft²·sec).

Traditionally (and as specified in part IV of Appendix F, 14 CFR § 25), the heat flux requirement is 3.5 W/cm² (3.08 BTU/ft²·sec). The increase in measured irradiance used in the present test method is a consequence of a change in the method used to determine the heat flux level. Previously the determination was made by inserting the calibration assembly into the heated section of the apparatus for a short period of time. The method according to the present disclosure requires the assembly to remain in the same position until conditions in the environmental chamber 304 become stable (as defined below). This change creates some additional heating of the calibration assembly, which slightly increases the sensor's output. The parameters have been adjusted to account for this shift in output to maintain previous heat flux levels and help improve reproducibility. The testing itself, therefore, is no more severe.

### 2.4 Thermopile

Thermopile refers to a device that continuously monitors the temperature of the air entering and exiting the environmental chamber 304. Once baseline temperature is determined, an increase in exit gas temperature is known to be directly proportional to the heat released by a burning material. Integrating such data over a given time yields the total amount of heat released during that period.

### 2.5 Mass Flow Controllers

Accurate, reliable gas flow delivery and control are crucial to this test method. Mass flow controllers (MFCs) provide precision measurement and control of airflow through the apparatus and gas flow for pilot burner operation (methane and air). Condensing liquids in the main chamber air and upper/lower pilot burner mixing air supply could damage mass flow control equipment. Air filters, dryers, chillers, and condensate traps should therefore be installed as needed to avoid damage.

### 2.6 Methane Gas (CH₄)

Methane gas (dry) may be used as fuel for an upper and lower pilot burners. For the test method, the methane gas should have a minimum purity of 99% and be regulated to a supply pressure of 25±5 psig (274±34 kPa) at the supply cylinder. Air from a main air supply may be used to mix air with methane gas for the upper and lower pilot flames, which should be regulated by the controllers/flow meters at 25±5 psig (274±34 kPa).

### 2.7 NIST Traceability

NIST refers to the National Institute of Standards and Technology (NIST; USA). NIST traceability refers to a calibration entity using NIST traceable calibration instrumentation.

### 2.8 Stability

The term ‘stable’, as it relates to heat flux density and chamber equilibrium, is a variable calculated using a moving average and expressed in terms of percent standard deviation over a defined period. Typically, stable conditions can be achieved between 60 and 90 minutes after heating has begun.

### 2.9 Heat Flux (60-Second Moving Average)

Heat flux refers to the instance when heat flux gauge (HFG) millivolt signal varies less than 1.0% standard deviation during the last 60 seconds and has a calculated heat flux density that is within range (see section 6, infra).

### 2.10 Chamber Equilibrium (15-Minute Moving Average)

Chamber equilibrium refers to the instance when thermopile temperature signal varies less than 1.0% standard deviation during the last 15 minutes commencing no sooner than 30 minutes after turning the heating elements of the HRR test apparatus on.

### 2.11 Standard Temperature and Pressure (STP)

For this test method, STP is 0° C. (273.15 K) at 760 mmHg (101.325 kPa) unless otherwise stated. Flow units are expressed as SLPM or NLPM and m³/s.

### 3.0 Principle of Operation

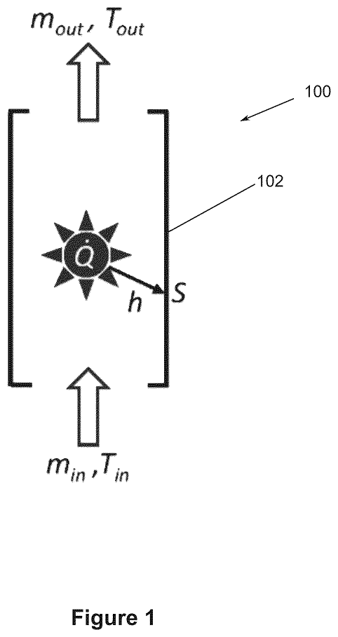

The principle of operation may be understood with reference to the figures. FIG. 1 depicts a schematic diagram of the HR2 apparatus 100, the apparatus 100 generally includes a combustion chamber 102 where the specimen is burned. In the preferred embodiment, chamber 102 has a volume V≈0.08 m³, which is bounded by interior surface S (m²). The heat generation rate within the HR2 apparatus is represented as \dot{Q}(W) and h (W/m²·K) represents the convective heat transfer coefficient from the heat source to the environment (walls and air stream).

### 3.1 Conservation of Mass

Neglecting the mass of combustion products in comparison to the air stream, system mass may be represented with the following equation:

$${\dot{m}}_{out} = {\dot{m}}_{in} = {ρ}_{in} {\dot{V}}_{in} = ρ \dot{V} \qquad ( 1 )$$

In Equation 1, ρ(kg/m³) and \dot{V}(m³/s) are the density and volumetric flow rate of the incoming air stream, respectively, at ambient temperature, e.g., Tᵢₙ=22° C. (295K).

### 3.2 Conservation of Energy

The rate of change of internal energy of the combustion stream relative to the ambient value mc_{P}(T−Tᵢₙ)=mc_{P}θ(J) is equal to the heat generation rate in the apparatus \dot{Q}(W) minus the heat lost to the apparatus at temperature T, where h (W/m²·K) is the convective heat transfer coefficient and S (m²) is the effective surface area of the chamber within the HR2. The energy balance for the HR2 combustion stream, assumed to be air with specific heat c_{P} (J/kg K) and mass flow rate, \dot{m}(kg/s)=ρ\dot{V}, may be represented by the following equation:

$$\frac{d}{dt} {( {mc}_{P} θ )}_{air} = {mc}_{P} \frac{d θ}{dt} + ρ {c}_{P} \dot{V} θ = \dot{Q} - hS θ \qquad ( 2 )$$

Separating variables in Equation 2 and defining an apparatus response time, τ=mc_{P}/(ρc_{P}\dot{V}+hS)=mc_{P}/Kₕ, where Kₕ (W/K) is the temperature coefficient of heat release in the HR2,

$$\frac{d θ}{dt} + \frac{θ}{τ} = \frac{\dot{Q}}{{mc}_{P}} \qquad ( 3 )$$

The difference between the temperature of the combustion stream exiting the apparatus Tₒᵤₜ and the constant ambient temperature of the air stream entering the apparatus Tᵢₙ at time t for an arbitrary heat generation rate \dot{Q}(t) is obtained by integrating Equation 3,

$$θ ( t ) = {T}_{out} ( t ) - {T}_{in} ( t ) = \frac{1}{{K}_{h}} {\int }_{0}^{t} \frac{\dot{Q} ( x )}{τ} exp [ - \frac{( t - x )}{τ} ] dx \qquad ( 4 )$$

Equation 4 is the general result for the temperature increase of the combustion stream with respect to ambient temperature for an internal heat generation rate \dot{Q}(t) that may vary with time.

### 3.3 Baseline

Prior to testing, the sample heat release rate is zero (\dot{Q}ₛ=0) and the baseline heat generation rate \dot{Q}_{BL} is the sum of the constant electrical power to the globar heating elements of the test apparatus,

$${\dot{Q}}_{GB}^{0} \approx 6000 W ,$$

and the constant combustion power of the methane pilot burner of the test apparatus,

$${\dot{Q}}_{pilot}^{0} \approx 900 W .$$

The baseline temperature is the solution to Equation 4 for a constant baseline power,

$${\dot{Q}}_{BL}^{0} = {\dot{Q}}_{GB}^{0} + {\dot{Q}}_{pilot}^{0} ,$$

$${θ}_{BL}^{0} = {T}_{BL} - {T}_{in} ( t ) = \frac{1}{{K}_{h}} ( {\dot{Q}}_{GB}^{0} + {\dot{Q}}_{pilot}^{0} ) = \frac{{\dot{Q}}_{BL}^{0}}{{K}_{h}} \qquad ( 5 )$$

The steady baseline temperature may be measured at a constant baseline thermal power,

$${\dot{Q}}_{BL}^{0} = {\dot{Q}}_{GB}^{0} + {\dot{Q}}_{pilot}^{0} \approx 6000 W + 900 W = 6900 W$$

is T_{BL}=340° C. (613K), so the temperature coefficient of heat transfer for an initial temperature Tᵢₙ (t)=22° C. (295K) may be represented as:

$${K}_{h} ≡ ( ρ {c}_{P} \dot{V} + hS ) = \frac{{\dot{Q}}_{BL}^{0}}{{θ}_{BL}^{0}} = \frac{6900 W}{613 K - 295 K} = 22 \frac{W}{K} \qquad ( 6 )$$

### 3.4 Methane Calibration

The burning of a constant metered flow of methane may be used to simulate the steady heat release rate of a burning sample to calibrate the HR2. The theoretical value of the constant methane power for the FAR calibration flow rate of three standard liters of methane per minute (3 SLPM=5×10⁻⁵ m³/s) at ambient temperature, Tᵢₙ (t)=22° C., may be represented as:

$${\dot{Q}}_{{CH}_{4}}^{0} = {( {H}_{c} ρ \dot{V} )}_{{CH}_{4}} = ( \frac{50.03 MJ heat}{kg {CH}_{4}} ) ( \frac{0.714 kg}{{m}^{3} {CH}_{4}} ) ( \frac{5.01 \times {10}^{- 5} {m}^{3} {CH}_{4}}{second} ) = 1790 W \qquad ( 7 )$$

The starting temperature for the methane calibration is T_{BL} at time t=0, and the temperature increase is,

$${T}_{{CH}_{4}} - {T}_{BL} = Δ {T}_{{CH}_{4}}^{0} \approx 98 K$$

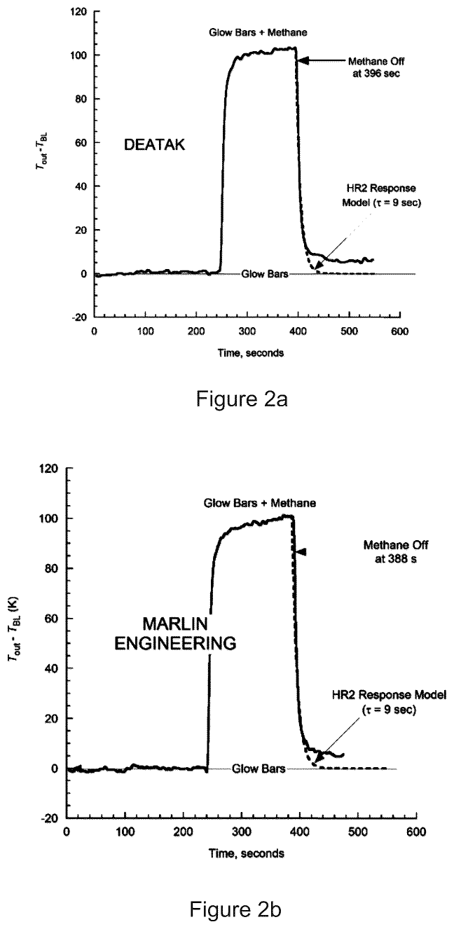

at τ=9 s (see FIG. 2). The temperature coefficient of heat release Kₕ for the methane calibration at a constant heat release rate (methane power),

$${\dot{Q}}_{{CH}_{4}}^{0} ,$$

and steady state temperature change,

$$Δ {T}_{{CH}_{4}}^{0} ,$$

(See FIGS. 2a-2b), may be represented as:

$${K}_{h} = \frac{\sum {\dot{Q}}_{i}}{\sum Δ {T}_{i}} = \frac{{\dot{Q}}_{{CH}_{4}}^{0} + {\dot{Q}}_{BL}^{0}}{Δ {T}_{{CH}_{4}}^{0} + {θ}_{BL}^{0}} = \frac{1790 W + 6900 W}{98 K + 318 K} = 21 \frac{W}{K} \qquad ( 8 )$$

The temperature coefficient of heat release, Kₕ, computed using Equation 8 is essentially the same as that obtained from the individual values for baseline power and baseline temperature change of Equation 6, showing that Kₕ is the proportionality constant between the total heat release rate and the total temperature rise of the combustion stream at time t,

$$\sum {\dot{Q}}_{i} = {K}_{h} \sum Δ {T}_{i} \qquad ( 9 )$$

FIGS. 2a-b depict a plot of ΔT_{CH}_{₄}(t)=T_{CH}_{₄}(t)−T_{BL} for standard methane calibration experiments in the Deatak and Marlin Engineering versions of the HR2. The time constant of the apparatus, t=9 s, is obtained by fitting the transient result of Equation 4 to ΔT_{CH}_{₄}(t) for a constant methane power, i.e., finding the best fit value of τ for,

$$Δ {T}_{{CH}_{4}} ( t ) = ( {\dot{Q}}_{{CH}_{4}}^{0} / {K}_{h} ) \{ 1 - exp [ - t / τ ] \} .$$

The effective thermal capacity of the HR2 may be represented as:

$${mc}_{P} = {τK}_{h} = ( 9 s ) ( 22 W / K ) \approx 200 J / K \qquad ( 10 )$$

The thermal capacity of the HR2 according to Equation 10 is more like the air in the combustion chamber, mc_{P}(air)≈102 J/K, than the thermal capacity of the steel HR2 apparatus, mc_{P} (HR2)≈104 J/K. This means that most of the sample combustion heat is transported out of the apparatus by the air stream during the first 2 minutes of a test. Although the loss of combustion heat to the apparatus is relatively small, it accounts for the gradual increase in the steady state temperature during the 2.5-minute methane calibration pulse in FIG. 2. The plateau temperature rise is slow because the apparatus response time is long, Tₐₚₚ=(mc_{P})ₐₚₚ/Kₕ≈(104 J/K)/(22 W/K)≈500 s.

### 3.5 Steady State Calculation of Sample Heat Release Rate

The heat release rate history of a sample in the HR2, \dot{Q}ₛ(t), is obtained by an inverse Laplace transform of Equation 4:

$${\dot{Q}}_{s} ( t ) = {K}_{h} \{ Δ T ( t ) + τ \frac{d Δ T ( t )}{dt} \} \qquad ( 11 )$$

The areal heat release rate HRR of a burning sample having surface area A may therefore be represented as:

$$H RR ( \frac{W}{{m}^{2}} ) = \frac{{\dot{Q}}_{s}}{A} = \{ \frac{{K}_{h}}{A} ( 1 + \frac{τ}{Δ T ( t )} \frac{d Δ T ( t )}{dt} ) \} Δ T ( t ) = {C}_{f} Δ T ( t ) \qquad ( 12 )$$

The bracketed term in Equation 12 is a constant in the FAR/legacy equation because it is obtained from the steady state methane calibration when dΔT/dt=0, so that

$${C}_{f} ≡ \{ Δ {\dot{Q}}_{{CH}_{4}}^{0} / Δ {T}_{{CH}_{4}}^{0} \} / A = {K}_{h} / A = ( 22 W / K ) / ( 0.02323 {m}^{2} ) \approx 950 W / {m}^{2} - K ,$$

according to Equation 8.

Equation 12 shows that Cf is not really a constant during a test because it depends on the rate of temperature change of the combustion stream, dΔT/dt, but since this quantity is not measured during the test, a post-test calculation using Equation 11 or a real-time compensation tab is used on similar fire calorimeters to estimate \dot{Q}ₛ(t) from the measured temperature history for research (not regulatory) purposes.

### 3.6 Dynamic Calculation of Sample Heat Release Rate

In terms of the total temperature change θ(t)=Tₒᵤₜ−Tᵢₙ, in the HR2, the sample heat release rate may be represented as:

$$H RR ( \frac{kW}{{m}^{2}} ) = \frac{{\dot{Q}}_{s}}{A} = \frac{θ ( t ) - {θ}_{BL}}{A} {K}_{h} ( t ) = \frac{Δ T ( t )}{A} {K}_{h} ( t ) = \frac{Δ T ( t )}{A} \frac{\sum \dot{Q}}{\sum Δ T} = ( \frac{Δ T ( t )}{A} ) ( \frac{{Q}_{BL}^{0} + {\dot{Q}}_{s}}{{θ}_{BL} + Δ T} ) \qquad ( 13 )$$

The temperature differences in Equation 13, θ(t)=Tₒᵤₜ−Tᵢₙ, θ_{BL}=T_{BL}−Tᵢₙ and ΔT=Tₒᵤₜ−T_{BL} are independent of the temperature scale (° C. or K) and are only a function of time. The baseline heat release rate may be represented as:

$${\dot{Q}}_{B L}^{0} = {K}_{h} {θ}_{B L} = {( ρ \dot{V} {c}_{P} + h S )}_{a i r} {θ}_{B L} \qquad ( 14 )$$

The sample heat release rate in Equation 13 is proportional to ΔT(t) by the methane equivalent heat release from calibration:

$${\dot{Q}}_{s} \approx ( {\dot{Q}}_{C {H}_{4}}^{0} / Δ {T}_{C {H}_{4}}^{0} ) Δ T = \{ {( ρ {H}_{c} \dot{V} )}_{C {H}_{4}} / Δ {T}_{C {H}_{4}}^{0} \} Δ T \qquad ( 15 )$$

Substituting Equations 14 and 15 into Equation 13 for a total temperature change,

$${θ}_{B L} + Δ T = ( {T}_{BL} - {T}_{i n} ) + ( {T}_{out} - {T}_{B L} ) = {T}_{out} - {T}_{i n} = θ ( t ) \qquad ( 16 )$$

gives the dynamic heat release rate of the sample in terms of air and methane properties without the need to compute dΔT/dt as per Equation 11,

$$H R R ( \frac{kW}{{m}^{2}} ) = \frac{Δ T ( t )}{A} \{ \frac{{( ρ {c}_{P} \dot{V} + hS )}_{a i r} {θ}_{B L} + \{ {( ρ {H}_{c} \dot{V} )}_{C {H}_{4}} / Δ {T}_{C {H}_{4}}^{0} \} Δ T ( t )}{θ ( t )} \} = \frac{Δ T ( t )}{A} {K}_{c a l c} ( t ) \qquad ( 17 )$$

The summation, K_{calc}=Σ\dot{Q}ᵢ/ΣΔT; that is the bracketed term in Equation 17 is equivalent to the model expression, Kₕ=mc_{P}/τ+d(mc_{P} dT)/dt, of the thermal model of Equation 11 because K_{calc} contains both steady (K_{BL}) and dynamic (K_{S}) parts:

$${K}_{B L} ( t ) = \frac{{( ρ \dot{V} {c}_{P} + h S )}_{a i r} {θ}_{B L}}{θ ( t )} and \qquad ( 18 )$$

$${K}_{S} ( t ) = \frac{τ {K}_{h}}{θ ( t )} \frac{d Δ T}{dt} = \frac{m {c}_{P} d Δ T / dt}{θ ( t )} = \frac{{\dot{Q}}_{c a l c}}{θ ( t )}$$

In the case of Equations 18, the HR2 thermal model (Equation 11) becomes:

$$H R R = \frac{Δ T}{A} \{ {K}_{B L} ( t ) + {K}_{S} ( t ) \} = \frac{Δ T}{A} {K}_{c a l c} ( t ) \qquad ( 19 )$$

At the start of test when θ(t)=θ_{BL}+ΔT=θ_{BL}, the calculated dynamic heat release coefficient K_{calc}(f) is equal to the static legacy coefficient, Kₕ=ρc_{P}\dot{V}+hS. The static and dynamic temperature coefficients are also equal at maxima or minima in HRR when dΔT/dt=0 so that Kₕ=K_{calc}(t).

To improve the agreement between the theoretical Equation 19 and the experimental HR2 data in the absence of a value for hS, and due to the uncertainty in the air properties at Tₒᵤₜ, the denominator of K_{calc}(f) in Equation 17 was approximated as, θ(1)=Tₒᵤₜ(K)−Tᵢₙ(K)=Tₒᵤₜ(° C.)−Tᵢₙ (° C.)≈Tₒᵤₜ (° C.), because under standard test conditions Tᵢₙ (° C.) is negligible compared to Tₒᵤₜ (° C.),

$$H R R ( \frac{kW}{{m}^{2}} ) = \frac{Δ T ( t )}{A} ( \frac{{( ρ \dot{V} {c}_{P} {θ}_{B L} )}_{a i r} + \{ {( ρ \dot{V} {H}_{c} )}_{{CH}_{4}} / Δ {T}_{{CH}_{4}}^{0} \} Δ T ( t )}{{T}_{o u t} ( ° C . )} ) = \frac{Δ T ( t )}{A} {K}_{c a l c} ( t ) \qquad ( 20 )$$

For temperature in degrees Kelvin and properties in MKS units, the dynamic HRR Equation 17 can be fit to the measured sample HRR using two constants that allow for automatic calculation of sample heat release rate from measured Tₒᵤₜ and Tᵢₙ at baseline and during sample testing,

$$HRR ( \frac{k W}{{m}^{2}} ) = \frac{Δ T ( t )}{A} ( \frac{{c}_{1} + {c}_{2} Δ T ( t )}{{T}_{out} - {T}_{i n}} ) \qquad ( 21 )$$

$$Where ,$$

$${c}_{1} \approx {( ρ \dot{V} {c}_{P} {θ}_{B L} )}_{a i r} and {c}_{2} \approx {( ρ \dot{V} {H}_{c} )}_{C {H}_{4}} / Δ {T}_{C {H}_{4}}^{0} \qquad ( 22 )$$

### 4.0 Apparatus

### 4.1 Heat Release Rate Apparatus

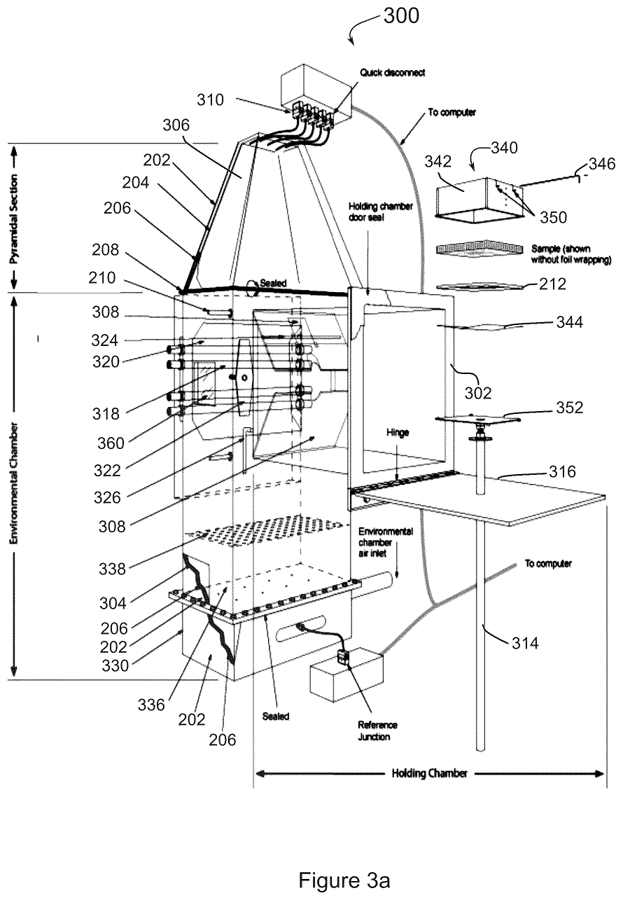

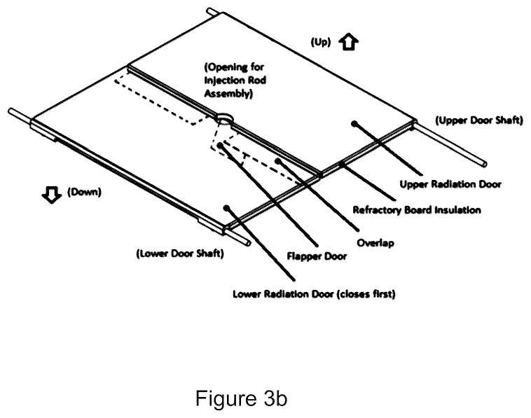

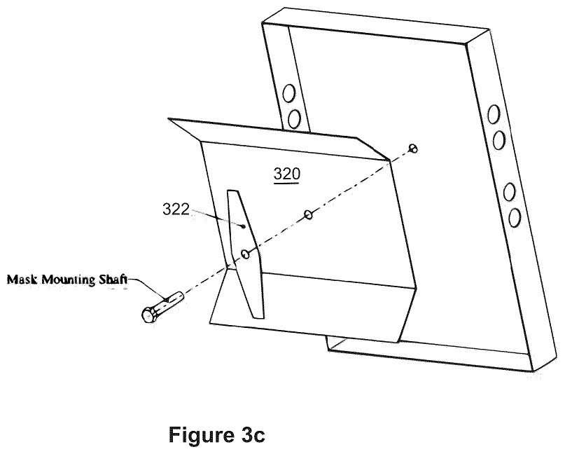

The test method disclosed herein use a modified version of the heat release rate apparatus standardized by the ASTM (ASTM E906) to determine HRR. Referring to FIGS. 3a-c, the apparatus 300 according to the preferred embodiment has three main sections:
1. Holding chamber 302
2. Environmental chamber 304
3. Pyramidal section 306

Environmental chamber 304 has a tubular structure that generally serves as a conduit for the combustion stream. In this respect, environmental chamber 304 has one or more of each of an inlet and an outlet opening, preferably at a lower end and an upper end of the chamber 304, respectively. The inlet opening supplies the air and the outlet opening provides the exhaust for combustion. The holding chamber 302 has a similar tubular structure that is coupled tangentially to the tubular structure of the environmental chamber 304, the interior volumes of which are selectively separated from each other by a radiation door panel assembly 308 (shown consisting of two doors hinged at a top and bottom of the opening at the intersection of the two chambers 302, 304, via a shaft 210, see also FIG. 3b). The pyramidal section 306 is coupled to the environmental chamber 304 at the outlet thereof, serving generally to direct exhaust gases to one or more thermopiles 310.

[symbol] All exterior surfaces of the apparatus 300, except the holding chamber 302, should be insulated, for example, with 1-inch-thick, low-density (8 pcf), high-temperature, Rockwool (mineral wool or stone wool) insulation 206, preferably having a thermal conductivity (K-value) of 0.23 BTU·in/(hr·ft²·° F.)±10% and all seams preferably taped. A thin aesthetic sheathing material or shroud 202 may be used to conceal/protect the insulation. Formed seams, butt joints, and corner joints are recommended in the construction of the apparatus 300, including the specimen holders 340. Except for the exhaust stack 204, lap joints in construction may be used, but should not exceed 0.375 inches (9.5 mm) and should be kept to a minimum.

### 4.1.1 Holding Chamber

The holding chamber 302 of the apparatus 300 acts as an antechamber, in which the specimen being tested is held (vis-à-vis the specimen holder) before ultimately being injected into the environmental chamber 304 for testing. In the preferred embodiment, the specimen is attached to a specimen injection rod 314 that is pivotally coupled to the holding chamber 302 via an outer holding chamber door 316 (i.e., the chamber door 316 is coupled to the holding chamber 302 via a hinge, as shown), such that the specimen holder 340 attached to a distal end of the injection rod 314 may be inserted (with the specimen) into the holding chamber 302 in an arcuate trajectory. The specimen injection rod 314 may be slidingly coupled to the holding chamber door 316 so that the rod 314 slides orthogonally through door 316 of the holding chamber 302, the rod having a snug fit with the door 316 to avoid air leakage. When door 316 is in the closed position, rod 314 slides between a retracted position and extended position. In the retracted position, the sample is located within the holding chamber 302 in preparation for testing, whereas in the extended position the rod 314 places the sample into the holding chamber 302 for testing, through the radiation door assembly 308, which may consist of one or more radiation door panels, as shown. Door 316 is preferably sealed relative to the holding chamber 302 to form an airtight closure and is hinged at the lower end of the access opening in holding chamber 302, for example, to make rapid injection of the sample into the environmental chamber 304 easier and, therefore, prevent excessive heat loss.

### 4.1.2 Environmental Chamber

The environmental chamber 304 contains radiation source 318, e.g., the radiant heating elements known as globars, preferably a reflector plate 320 (behind the radiation source 318), and a diamond-shaped mask 322 (in front of the radiation source 318, between it and the sample being tested) to aid in heat flux uniformity, an upper burner 324 to ignite any surplus combustible residues released during the test, a lower pilot burner 326 to initiate combustion of the specimen, air distributor plates 336, 338 that provide a constant laminar flow of air through the apparatus, and a lower plenum 330 that contains the air inlet port 332 and the cold junction 334 of the thermopile. The area between the upper and lower air distributor plates 336, 338 is commonly referred to as the interspace area.

The environmental chamber 304 preferably also contains a two-part, hinged/insulated radiation door assembly 308 that separates the holding chamber 302 from the environmental chamber 304. As shown, in FIGS. 3a and 3b, the assembly 308 may include an upper door hinged at the top of the opening between the chambers 302, 304 and lower door hinged at the bottom of this opening. The radiation doors may be constructed of two sheets of 0.030±0.003 inch (0.76±0.08 mm) stainless steel with a layer of the 0.25 inch (6.4 mm) rigid refractory board in between. Doors 308 may have an overall thickness of approximately 0.31 inches (7.9 mm) with a horizontal overlap where they meet in the center and a door flap/flapper to cover the injection rod-hole opening, as shown in FIG. 3b, when the injection rod 314 is placed in the retracted position for testing.

To provide a view for observation, there may be a 4±0.5 inch (102±12.7 mm) by 4±0.5 inch (102±12.7 mm) heat-resistant window 360 may be located on one side of the environmental chamber 304. A sealed hinged-type access is permissible and will help to improve accessibility for maintenance work and cleaning.

### 4.1.3 Pyramidal Section

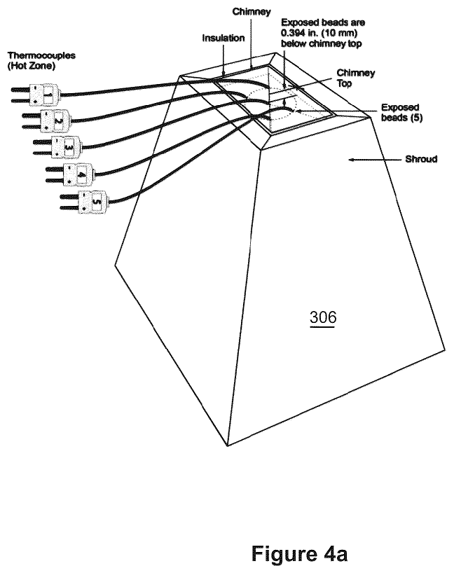

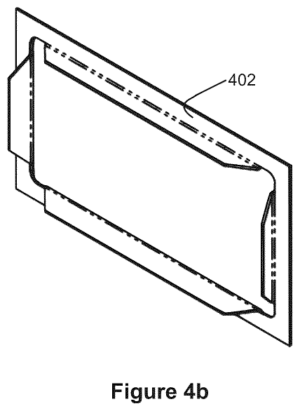

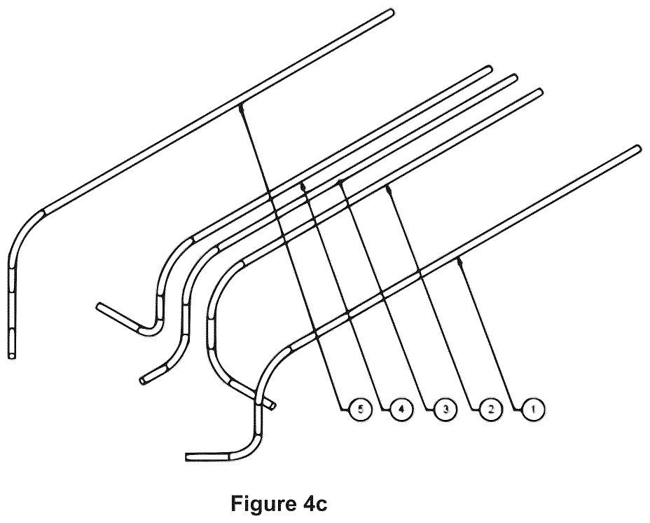

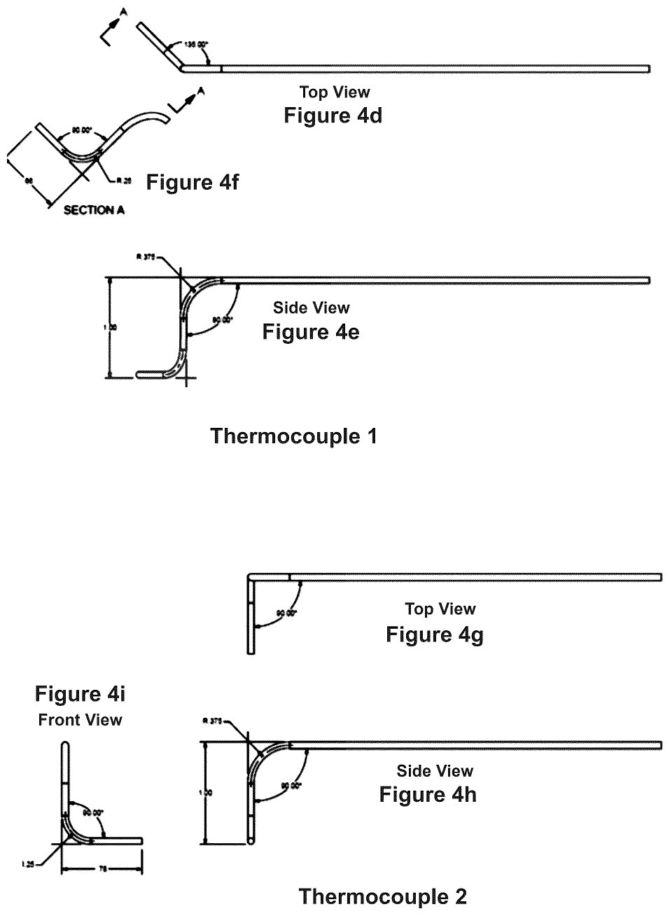

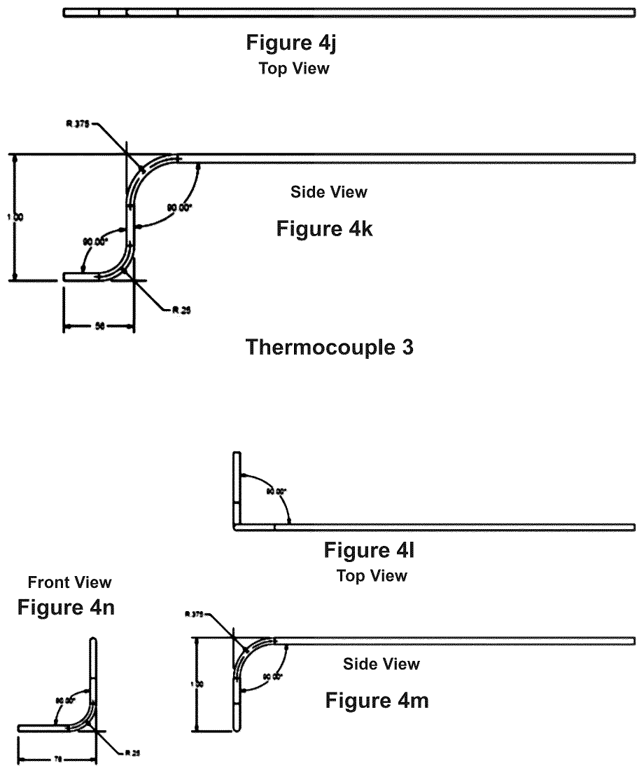

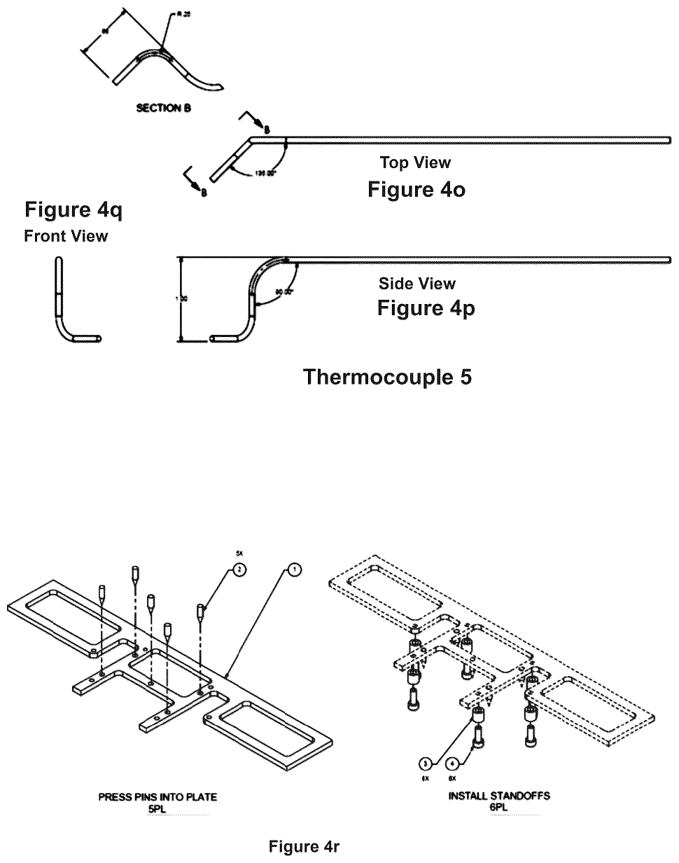

The pyramidal section 306 acts as a chimney or exhaust stack for the environmental chamber 304. In this regard, section 306 has a similar tubular structure with inlet and outlet openings. Sensors located at the pyramidal section 306, preferably at or about the outlet opening, measure the average exhaust gas temperature as it exits the system 300, as discussed in Section 4, infra. This section 306 may be fastened to the environmental chamber 304 at the outlet thereof using 28 #10-32 by 0.75 inch (19 mm) bolts, washers, and nuts distributed around the perimeter flange. A 0.048±0.004 inch (1.2±0.1 mm) steel stiffening doubler 208 and gasket 210 may be used to form an airtight seal between the components 304, 306. A stiffening section 402 may be used at the outlet to stabilize the cross section at the thermocouples, as shown in FIG. 4b.

As discussed above, the HR2 updates the prior HRR test equipment, by inter alia, adopting a single plenum design. That is, pyramidal section 306 is a single plenum structure and therefore does not contain an additional plenum for supplemental cooling air flow. The pyramidal exhaust stack 306 should be constructed using formed seams, butt joints, or corner joints. No lap joints should be permitted. A covering or shroud 202 made of 0.036±0.003 inch (0.9±0.08 mm) aluminum should be used to conceal and protect the exhaust stack insulation (as shown in FIG. 3a). Aside from insulation, nothing should be attached to or in contact with the pyramid-shaped exhaust 306 that could impact heat release data or impede the gas flow from exiting the system, including thermopile support bracketry.

### 4.2 Apparatus Components

### 4.2.1 Radiation Source

A power supply for the system capable of producing 12 kVA is satisfactory but not required. The radiation source 318 should be adequately protected from variations in the power supply. A device for monitoring the voltage and current through each globar during testing should be provided. Line voltage fluctuations to the globars shall not exceed +/−1.0%.

A radiant heat source 318 may be used that consist of a plurality of, preferably four, silicon carbide elements, 20 inches (508 mm) in length (L), 0.63 inch (16 mm) diameter (D), 12 inch (305 mm) central hot zone (CHZ) with two low resistivity cold ends and a total nominal resistance at 1000° C. (1273 K) of 1.4 ohms±15%. The use of globar sets of similar amperage ratings is recommended to aid in even heat distribution across the test specimen. The silicon carbide heating elements may be mounted in a 2-inch (50.8 mm) deep stainless-steel pan by inserting them through 0.63-inch (16 mm) holes in ceramic insulating devices or calcium-silicate millboard.

A stainless-steel, truncated mask 322, preferably diamond-shaped 0.042±0.004 inches (1.1±0.1 mm) thick and a stainless-steel reflector plate 320, preferably 0.036±0.003 (0.91±0.08 mm) thick inches may be added to provide uniform heat flux over the area occupied by the specimen inserted into the chamber 304. The mask 322 may be positioned vertically and the sloped areas of the plate 320, top, and bottom, which may be 3.15 inches (80 mm) in length, can be adjusted for this purpose. A 0.5-inch (12.7 mm) diameter machine screw or equivalent, approximately 4 inches (102 mm) in length, may be used to mount the mask 322 into position over the radiation source 318 to mask it accordingly. Typically, the mask 322 position is located inward (toward the specimen) approximately 3 inches (76 mm) from the reflector plate. The shaft head or nut on the side of the mask should face the specimen (no threads extending toward the specimen). See FIG. 3c.

Variable control of power to the upper and lower globar of the radiant heat source 318 individually or in pairs allows for refined heat flux uniformity adjustments. Care must be taken not to alter the uniformity while making minor daily heat flux adjustments (see Sections 6.1 and 6.2, infra).

### 4.2.2 Thermopile

The temperature difference between the air entering and leaving the apparatus 300 (for the HRR calculation) should be continuously monitored, preferably using a thermopile 310 constructed of Type K-chromel (nickel-chromium alloy)/alumel (nickel-aluminum alloy) material. The chromel wire is generally yellow in the USA and green in Europe; the alumel wire is red in the USA and white in Europe. Color coding of the thermocouple wire should be checked to ensure correct usage.

The components of the thermopile 310 may include a plurality, preferably at least five hot zone thermocouples (at or about the outlet opening(s)), one reference thermocouple (cold junction at or about the air inlet port 332), and an extension harness leading to a data-acquisition system (Sec, e.g., FIGS. 3a, 4a-4c, and 21). The six thermocouples may be 0.0625±0.007 inches (1.59±0.18 mm) in diameter, not exceeding 12 inches (305 mm) in length with stainless-steel sheathing. The thermocouples may have an exposed bead junction (ungrounded) 0.030±0.006 inches (0.76±0.15 mm) in diameter and a quick disconnect connection. The distance from the end of the temperature-sensing tip to the sheathing should not exceed 0.125 inches (3.2 mm).

The (five) hot zone thermocouples may be functionally located in the pyramidal section 306 about 0.394 inches (10 mm) below the top of the exhaust stack (see FIG. 4a-4r). One of the thermocouples may be placed at the geometric center of the exhaust stack cross-section, and the other four may be placed on the exhaust (radially) diagonals about 1.18 inches (30 mm) from the center thermocouple when viewed in plan view from the top, see FIGS. 4c and 4r (showing template for placement at placement pins). As can be seen, the ends of the thermocouples may be placed along a single horizontal plane within the outlet of the pyramidal section. To protect the connectors of the thermocouple from excessive heat from the globars within the environmental chamber 304, the delicate parts of the thermocouples should be positioned above the holding chamber 302 side of the exhaust stack, as shown. The hot zone thermocouples may be cleaned using a spray of distilled water. A Type K extension harness may be used to connect each of the five hot zone thermocouples and the reference thermocouple to the data-acquisition system. The wiring may be a 24-gauge solid conductor thermocouple-grade wire with quick disconnect connections on each end to accommodate the thermocouples.

Referring to FIG. 4c-4q, thermocouples 1-5 are depicted in various views. Generally, the thermocouples are horizontal and parallel to each other for a first (outer) portion thereof, and then each thermocouple transitions into a plurality of compound curves to place the end thereof at the desired location. The first and fifth, and the second and fourth thermocouples are mirror images (three dimensionally) of each other. The thermocouples each includes a first curve that changes the direction thereof (horizontal to vertical), and as second curve that changes the direction from vertical back to horizontal, as shown, so that the ends of the thermocouples are below the upper open end of the pyramidal section 306 and at the desired location relative to the end of the center thermocouple, as discussed above. The location of the thermocouple ends may be located with the jig shown in FIG. 4r. As can be seen, the jig has a structure that fits within the exhaust opening at the pyramidal section 306 and includes pins that assist in the placement of the ends horizontally in the pyramidal section 206 and the standoffs that assist with the vertical placement of the ends of the thermocouples.

A leak-tight connection may be used for the reference junction thermocouple where it enters the lower plenum (inlet opening 332) into environmental chamber 304. This thermocouple sensing tip is preferably geometrically centered in the plenum below the distribution plate 336, 338. Sealed access ports should be provided to facilitate periodic inspection, cleaning, maintenance, and pressure measurements.

### 4.2.2.1 Calculation of Thermopile Temperature Output

The thermopile temperature may be calculated as the temperature differential (ΔT) between the air entering and leaving the environmental chamber 304. Each of the five hot zone thermocouple inputs may be recorded and the average value determined for use as for Tₒᵤₜ. The reference junction temperature (Tᵢₙ) may then be subtracted from the average hot zone temperature to calculate the temperature rise (ΔT) of the thermopile signal. Annual calibration of each thermocouple and temperature input (DAQ) should be required. As discussed above, this process using absolute temperature differential for determining HRR of the material differs from that using the calibration base temperature, which obviates the need for methane calibration.

### 4.2.3 Lower Pilot Burner

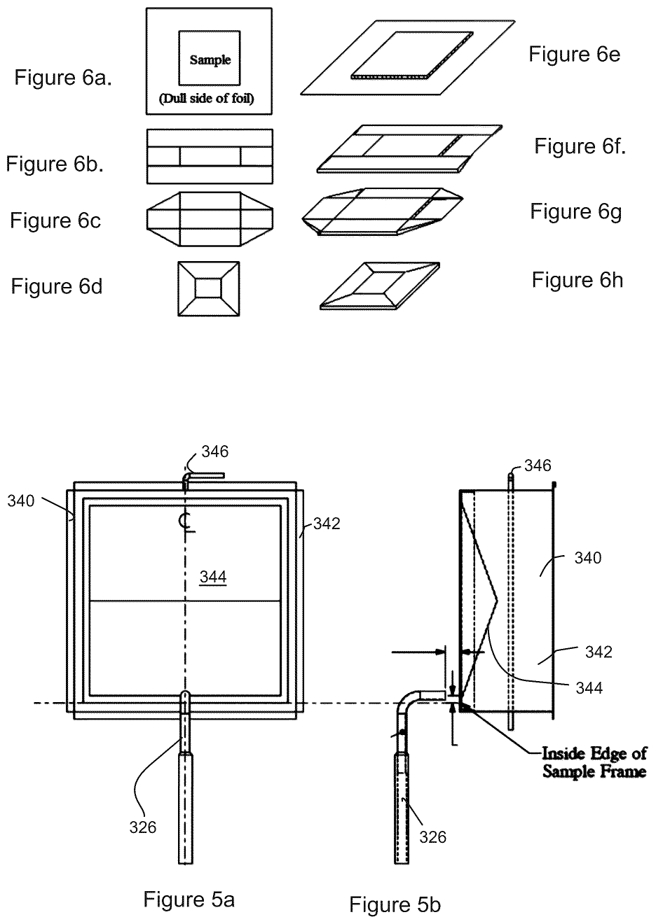

The lower pilot burner 326 is located within the environmental chamber 304 at the approximate location of the specimen inserted into the chamber 304 (i.e., the specimen rod 314 extended into the chamber 304), which helps initiate the burning process of materials during testing (see Sections 4.2.8.2 and 6.3, infra). Lower pilot burner 326 may be constructed from stainless steel tubing with a nominal OD of 0.25 inches (6.4 mm) and have a wall thickness of 0.03 inches (0.76 mm) (see FIG. 5a-5b). Preferably, the normal position of the end of the pilot burner tubing is 0.394 inches (10 mm) from and perpendicular to the exposed vertical surface of the specimen inserted into chamber 304. The centerline at the outlet of the lower pilot burner 326 tubing should intersect the vertical centerline of the sample at a point 0.197 inches (5 mm) above the lower exposed edge of the specimen (see FIG. 8).

A mixture of 120±15 milliliter/minute (mL/min) of methane and 700±50 mL/min of air (STP of 21° C./1 atm.) should be fed to the lower pilot burner 326. The test may be deemed invalid if there is any period longer than 3 seconds when the flame is not burning. Note, pilot-burner flow settings are referenced to sea-level conditions. Facilities located at higher elevations should adjust flow accordingly. When adjusted properly, these flow settings produce a pointed, luminous inner-cone flame approximately the same length as the OD of the burner tube (0.25 inches) and a dim outer cone approximately 0.5 inches in length.

### 4.2.4 Upper Pilot Burner

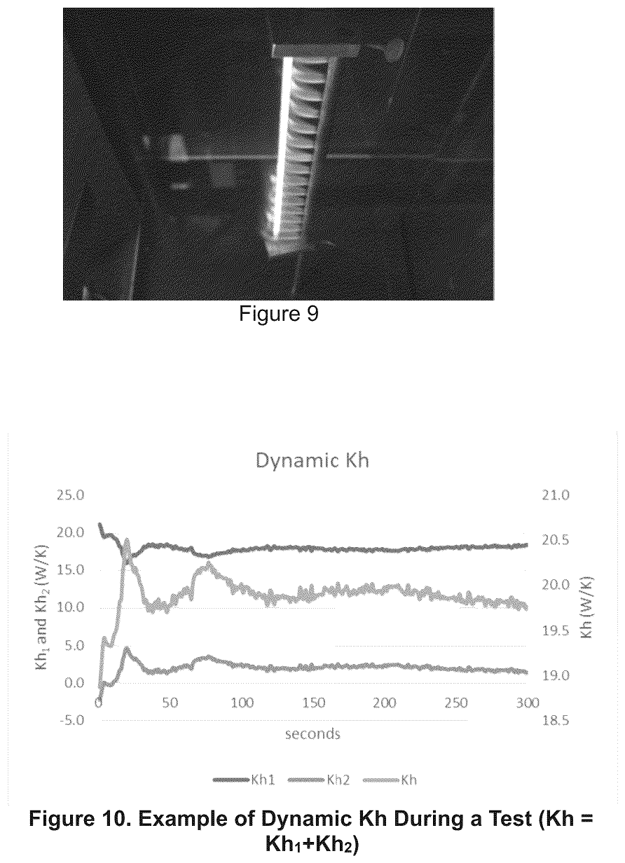

The purpose of the upper pilot burner 324 is to ignite off-gassing products during testing. The burner may be constructed from a 15-inch (381 mm) length stainless-steel tubing with an OD of 0.25 inches (6.4 mm) and a wall thickness of 0.03 inches (0.76 mm) (see FIG. 6). Preferably, 15 holes 0.041±0.0005 inches (1.0±0.01 mm) in diameter, each radiating in the same direction, may be drilled into the tubing. A #59 drill bit provides the proper hole diameter. The holes in the upper pilot burner 324 are preferably spaced 0.5 inches (12.7 mm) apart with the first hole located 0.5 inches (12.7 mm) from the closed end (see FIG. 9). Each hole should be completely burr-free inside and outside, but not chamfered.

The upper pilot burner 324 may be inserted into the environmental chamber 304 through a 0.25-inch (6.4 mm) hole drilled therein to locate the centerline of the upper pilot burner 324 tubing 0.875 inches (22.2 mm) above and 0.875 inches (22.2 mm) behind the upper front edge of the specimen holder 340 (when inserted into the environmental chamber 304). The upper pilot burner 324 tubing should be oriented such that the holes therein are directed horizontally toward the radiant heat source 318. One end of the tubing should be closed, for example, with a silver solder plug or equivalent.

It is important that the upper pilot burner 324 tube is not moved out of position once set correctly in the desired location. If the tube is inadvertently moved forward (toward the globars), there is a chance that a large portion of the upper pilot flames will extinguish completely in the presence of fire retardants that may be emitted from the specimen, whereas when in the correct position, only the flame tips are impacted in this regard while the specimen material is burning off. The difference between the two conditions could have a significant effect on the data.

For testing, the upper pilot burner 324 used methane gas set to 1.5±0.03 SLPM (2.5±0.05×10⁻⁵ m³/s) then mixed with air set to 1.0±0.02 SLPM (1.66±0.033×10⁻⁵ m³/s) via the MFCs. During the test, if there is any period longer than 3 seconds when any three or more of the flames on the upper pilot burner are not burning, the test is deemed invalid. Note, when adjusted properly, these flow settings produce upward-bending blue flames, having a yellow tip (0.25 inches). The overall flame length is approximately 1 inch.

### 4.2.4.1 Upper Pilot Burner Hot Surface Igniter (HSI)

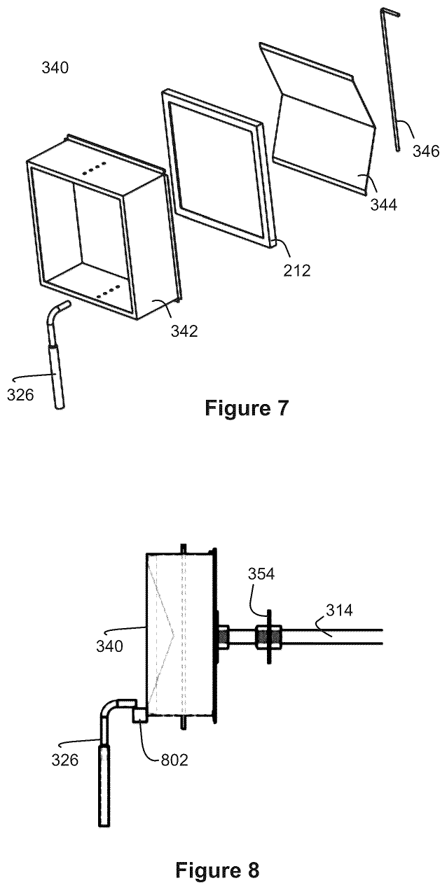

A ceramic HIS rod 702, preferably 0.125±0.005 inch (3.2±0.1 mm) diameter and 8.0±0.5 inches (203±12.7 mm) in length may be positioned directly in the flames of the upper pilot burner 324 (see FIGS. 7 and 8). HSI rod 702 is continuously heated by the flames of the burner 324, acting as a hot-surface igniter to auto-ignite any upper pilot flames should they go out. The distance from the centerline of the upper pilot burner tube 324 to the centerline of the HSI rod may be 0.75±0.125 inches (19±3.2 mm).

Two stainless-steel support brackets for the HIS rod 702 may be mounted on the upper pilot burner 324 tube. The brackets may be separated 8.0±0.06 inches (203±1.6 mm) from each other (outer dimension) with one bracket aligned flush with the closed end of the burner tube. The upper pilot burner 324 flames tend to curve upward because of forced airflow through the chamber and convection. To locate the HSI rod in the hottest portion of the burner flames, the brackets may be rotated upward 15±5° on each end. Setting the bottom of the bracket level will achieve the correct angle. Each bracket does not need to be at the same angle, provided the rod is in the direct flame path across its entire length (see FIG. 9). Set screws may be used to secure the brackets in position. The HSI rod must be cleaned or replaced when showing signs of soot buildup or wear.

### 4.2.5 Electronic Igniter System

An igniter system for the upper and lower pilot burner may be used to relight the flames to ensure they do not extinguish for more than 3 seconds during the test. If an electric sparking device is used, an appropriate method of suppression and equipment shielding must be applied so that there is limited or preferably no interference with the ability of the data-acquisition equipment to accurately record data. Care must be taken to ensure the igniter(s) do not interfere with or shade the heat flux gauge (HFG) center or corner reading while determining heat flux levels. Also, the ignitor should not come in contact with the sample holder drip pan during testing.

### 4.2.6 Air Distribution System(s)

A dried and well-regulated supply of air is required for main chamber airflow as well as pre-mixed gas (methane and air) for upper and lower pilot burner operation. The supplied air should be clean and free of non-condensing water vapor (≤65% RH), oil mist, and foreign particles.

### 4.2.6.1 Airflow Mass Flow Controller

Airflow through the apparatus 300 should be precisely measured and controlled using, e.g., a mass flow controller (MFC), and should have a pressure-regulated input, preferably 25±5 psig (274±34 kPa). Airflow is measured in standard cubic feet per minute (SCFM) referenced to STP 0° C. (273.15 K) at 760 mm Hg (101.325 kPa). The flow rate through the environmental chamber 304 may be set to 20.0±0.4 SCFM (9.44±0.18×10⁻³ m³/s) at 22.5±1.4° C. (296±1.4 K). The MFC should be calibrated for air annually with NIST traceability. The airflow meter should have a minimum accuracy of ±2% of full scale. The MFC should also be coupled to provide a signal output to a data-acquisition system used for monitoring and/or controlling airflow.

The main airflow MFC connection should be at or about the inlet port 332 in the lower air plenum 330, preferably within 24 inches or less from the port 332 (see Section 4.4.2.6.2, infra). The air inlet connection should use only straight pipe or fittings (no angles or bends are permitted). If the inner diameter of the main airflow MFC outflow connector is not 1.5 inches, the run from/to the air inlet port 332 should include a transition to the 1.5-inch inner diameter. Static pressure and airflow temperature should be measured either in the straight run (after the 1.5 inch ID transition, if present) or inside the lower air plenum 330. Static pressure should be measured at or just beyond the inner surface of the inlet 332 pipe or lower air plenum 330. Static pressure and airflow temperature should be measured and recorded preferably at a frequency of once per minute, at a minimum.

### 4.2.6.2 Air Distribution Plate

The environmental chamber 304 airflow enters through, e.g., a nominal 1.5-inch (38 mm) port in the lower air plenum 330 and is distributed by a distribution plate 326, preferably 0.25-inch (6.4 mm) thick aluminum plate having eight 0.209±0.001 inch (5.3±0.03 mm) diameter holes located about 2 inches (50.8 mm) from the side walls of the environmental chamber 304 on 4 inch (101.6 mm) centers. A #4 drill provides the proper hole diameter. The plate 336 may be mounted between the lower plenum 330 and the base of the environmental chamber 304, as shown in FIG. 3a, with a leak-tight connection. Each hole should be completely burr-free on each side but not chamfered.

Note, the hole diameter mentioned in this plate 336 (8) is important. Incorrect sizing may cause high or low back pressure in the main air supply (lower plenum pressure) resulting in increased or decreased air velocities through each orifice. This may impact peak heat release rate (PHRR), time to PHRR, and Total HR of materials during testing. Therefore, the number and size of the holes may be configured to achieve the desired velocity through each part of the apparatus 300.

### 4.2.6.2 Second Stage Plate

A removable second-stage plate 338 may be used, preferably constructed of stainless steel 0.048±0.004 inches (1.2±0.1 mm) thick and mounted 6±0.25 inches (152±12.7 mm) above the air distribution plate 336. The plate 338 may have a plurality of holes, preferably 120 holes, 0.140±0.001 inches (3.6±0.03 mm) in diameter. A #28 drill provides the proper hole diameter. The hole pattern may be centered on the plate within the environmental chamber and spaced in rows of 15 along the long dimension at 1 inch (25.4 mm) spacing and rows of 8 along the narrow dimension at 0.875 inch (22.2 mm) spacing. Each hole should be completely burr-free on each side but not chamfered. The plate should be mounted such that the perimeter is sealed airtight to force all airflow through the chamber 304 through the 120 holes in the second stage plate 338. Other hole dimensions may be used to provide the desired laminar flow within chamber 304.

### 4.2.6.4 Specimen Holder

Specimen holders 340 may be used to hold the material being tested at the desired location within the environmental chamber 304 during testing. Generally, the specimen holders 340 are configured to attach to the distal end of the specimen rod 314, which is manipulated to insert at the desired time the material or part being tested into the environmental chamber 304 from within the holding chamber 302 initially (see FIG. 8). Further, the holders 340 maintain the material in a vertical orientation with a portion of the specimen facing the radiant heat source 318, as shown.

Referring to FIG. 8, holders 340 may be fabricated from a stainless-steel sheet 0.018±0.002 inches (0.46±0.05 mm) thick. Each holder 340 may be provided with a specimen holder frame 342 having a flange at a front face thereof so that the holder 340 touches the specimen only along the perimeter of the holder (thereby leaving a portion of the specimen exposed), a V-shaped spring plate 344 that presses the specimen forward toward the front face of the frame 342 (vis-à-vis retaining ring 212), and a retaining rod 346 (placed behind the spring plate) that holds the assembly together by retaining the spring plate 344 in a bias toward the specimen/retaining ring 212. The position of the spring pressure plate 344 within the frame 342 can be changed to accommodate different specimen thicknesses by inserting the retaining rod 346 in different holes 348 of the specimen holder 340. Applying equal spring plate pressure to specimens of equal thickness by inserting the specimen retaining rod 346 in the same holes 348 for each specimen tested is recommended.

Each holder 340 may also have 0.020 inch (0.51 mm) stainless-steel wires 350 (2) attached vertically to the front of the holder 340, as shown in FIG. 3a, to secure the face of the specimen in the holder 340. When testing, these wires 350 should be in place for all specimens.

### 4.2.6.5 Drip Pan

Drip pans are for optional use to prevent melting specimens from dripping into the lower test section of the environmental chamber 304. A drip pan may be fabricated from a stainless-steel sheet 0.018±0.002 inches (0.46±0.05 mm) thick and clipped to the specimen holder using attachment flanges (see FIG. 8). Foil may be used to line the drip pan to facilitate cleaning after use.

### 4.2.6.6 Holding Chamber/Injection Mechanism

The specimen holder 340 may be attached to an injection mechanism mounting plate 352, which is further attached to the distal end of the specimen rod 314, as shown in FIGS. 3a and 8. The plate 352 is preferably made of 0.036±0.003 inch (0.91±0.08 mm) stainless steel, which incorporates metal locking tabs that removably secure the specimen holder 340 in place on the plate 352. A large area washer 354 on rod 314 may form a tight seal with the inner radiation doors when closed. The face of the specimen, when inserted into the holding chamber 302 for testing, should be located 9±0.5 inches (229±12.7 mm) from the inner radiation doors. When the specimen is inserted into the environmental chamber 304, the front surface of the specimen is preferably situated vertically in the chamber 304 and is preferably parallel to the set of the radiant heat source 318 elements and located 3.94 inches (100 mm) from the inner wall of the environmental chamber 304 at the side of the radiation doors.

### 4.2.8 Calibration Equipment

### 4.2.8.1 Heat Flux Gauge (HFG)

Two water-cooled HFGs may be used to determine the total heat flux density applied to the material being tested. One gauge is preferably used to measure heat flux at a point where the center of the specimen surface is located (within the environmental chamber 304) at the start of testing. A corner HFG is preferably used to determine heat flux uniformity, and its centerline is located diagonally 2.75±0.25 inches (70±12.7 mm) from the center of the specimen.

The HFG cooling water temperature, pressure, and flow should be maintained within the manufacturer's recommendations. Cooling water temperature should be maintained to ensure no condensation occurs on the gauge surface at any time. Cooling water circuits should not be connected in a series. Rigid tubing should be used for the cooling water lines because of the high temperatures within the environmental chamber 304.

Each HFG preferably has a thin, full-faced, opaque coating of high-temperature, high-emissivity, ultra-flat black paint. The sensitivity of the gauge is a function of the surface condition. Changes in the coating may cause drift in the overall performance of the gauge. Regularly inspection of the measuring surface for physical damage or dust particles that may have accumulated is recommended. Cleaning can be accomplished by gently wiping a soft, water-dampened sponge across the sensor face. Damage to the coating during the cleaning process will affect the measurement accuracy of the sensor. To maintain accuracy, the measuring surface should be recoated at regular intervals, followed by recalibration.

The HFGs may be mounted in a supporting device in a sample holder assembly or equivalent, protruding through a 0.5-inch (12.7 mm) thick rigid refractory board having a density of 50±10 lb./ft³ (800±160 kg/m³). Each gauge has a 180° field of view; therefore, the HFG surface should be mounted flush with the insulation board and not recessed. The gauges should be parallel to the radiant heat elements when positioned in the environmental chamber 304 to measure heat flux. The complete assembly shall be lightweight to minimize warmup time while in use. The HFGs should be calibrated annually.

### 4.2.8.2 Methane/Mixing Air Mass Airflow Controllers (MFCs)

Thermal-based MFCs having nominal 0.25 inch (6.4 mm) inlet/outlet fittings may be used to provide precision measurement and control of gas flow for the upper pilot burner 324 flame during testing. The methane MFC should be calibrated annually with NIST traceability for methane gas and should be capable of controlling flow rates up to 4 SLPM (6.66×10⁻⁵ m³/s). The meter/controller should have a minimum accuracy of ±1% of full scale and is referenced to STP 0° C. (273.15 K) at 760 mm Hg (101.325 kPa). The controller should have a response time of 2 seconds or less to get within ±2% of the final value. The upper pilot burner 324 mixing air MFC should have the same requirements; however, it should be calibrated for air. The MFCs should have a signal output to a data-acquisition system used for monitoring gas flow.

### 4.3 Data-Acquisition System/Display Devices

The data-acquisition system and indicating devices (millivolt, flow, temperature, etc.) for displaying data from the various sensors and other components should be calibrated annually to NIST traceability with a measurement uncertainty of less than 1.0% reading.

Digital Data Collection—The data collection system that is used for testing should have facilities for recording the output from the HRR apparatus sensors, such as the mass flow controllers, heat flux gauges, and thermocouples. The data collection system should have an accuracy corresponding to at least 0.5° C. for the temperature measuring channels, and 0.01% of full-scale instrument output for all other instrument channels. The system should be capable of recording data at intervals of once per second (1 hertz).

The system preferably also includes programming to store the data collected during testing in one or more databases, and to process the data collected as discussed herein, including regarding calculating the heat release rate (HRR) of materials using the novel approach disclosed in the present application based on absolute temperature differences further based on the empirical relationship between the relevant variables and the calculated heat release coefficient, as discussed in Section 8, infra.

### 5.0 Test Specimens

### 5.1 Specimen Number

Several specimens of a material or part of interest should be tested for HRR. A minimum of three specimens should be prepared and tested for each material/part of interest.

### 5.2 Specimen Size

Specimen size should be standardized for consistency. The standard size for the prepared specimens may be 5.94±0, −0.06 (151±0, −1.5 mm) by 5.94±0, −0.06 inches (151±0, −1.5 mm) in lateral dimensions. For calculation purposes, the area of the specimen is 36 in² (0.02323 m²). Specimen thickness is used in the relevant application up to 1.75 inches (44.5 mm); applications requiring thicknesses greater than 1.75 inches (44.5 mm) may have specimens constructed for testing in 1.75 inch (44.5 mm) thicknesses.

### 5.3 Specimen Preparation

It is preferred that only one surface of a specimen is exposed during an HRR test. A single layer of 0.0012±0.0005 (0.03±0.01 mm) inch-thick aluminum foil may be wrapped tightly on all unexposed sides with the dull side of the foil facing the specimen surface (see FIG. 6a-6h) in this regard. The foil should be continuous and not torn.

The specimen may be attached to the specimen holder frame 342 for testing by first placing the foil wrapped specimen in frame 342 with the back of the specimen facing the V-shaped spring plate 344. After the specimen is placed tightly into the specimen holder 340, all aluminum foil on the side exposed to the heat elements 318 should be removed/trimmed to avoid covering any of the exposed specimen areas (beyond the flange on the face of the specimen holder frame 342) or obstructing airflow across the material surface. When trimming excess foil from the test specimen, care must be taken not to score or make an incision into the perimeter surface of the material being tested. As discussed above, wires 350 may be placed across the front face of the holder 340 to further secure the specimen to the holder 340.

### 5.4 Specimen Orientation

For materials that may have anisotropic properties (i.e., different properties in different directions, such as machine and cross-machine directions for extrusions, warp, and fill directions of woven fabrics), the specimens should be tested in both orientations, and both must meet the necessary requirements.

### 5.5 Conditioning

Specimens should be conditioned prior to testing. For example, specimens may be maintained in an environment at 21±2° C. (294±2 K) and 55±10% RH for a minimum of 24 hours before testing. The conditioning equipment should be calibrated annually, and the parameters checked daily for proper operation. If possible, only one specimen at a time should be removed from the conditioning environment immediately before being tested. If this is not possible, it is acceptable to remove more than one specimen at a time if each specimen is placed in a closed container to protect it from contamination until it is subjected to the flame.

### 6.0 Calibration Procedure of Equipment

### 6.1 Heat Flux Calibration (Center Position)

For the determination of total heat flux density, a heat flux sensor may be positioned at a point where the center of the specimen would be located at the start of testing. The center heat flux should be 3.65±0.05 W/cm² (3.21±0.04 BTU/ft²·sec) and verified daily before testing. The HFG should remain exposed to the radiant heat source inside the environmental chamber, with radiation doors closed, and the heat source controlled until a stable reading is achieved (see Section 2.10).

An adjustable stop in the insertion mechanism, together with a positioning template, should be used to ensure the HFG adopts the correct position when inserted into the environmental chamber 304. This will improve the repeatability of the heat flux measurement.

### 6.1.1 Procedure

6.1.1.1—Verify air and methane gas are off at the upper and lower pilots.
6.1.1.2—Ensure the lower and upper pilot burners are positioned correctly.
6.1.1.3—Turn on the airflow through the environmental chamber (see Section 4.2.6).
6.1.1.4—Verify cooling water is flowing to the HFGs and output wiring is connected to the data-acquisition system (see Section 4.2.8.1).
6.1.1.5—Position and secure the HFG calibration assembly into the holding chamber, ensuring an airtight seal. Insert the HFGs into the environmental chamber hot zone, close the inner radiation doors, and begin recording the transducer millivolt outputs.
6.1.1.6—Turn on the power to globars and begin heating the apparatus.
6.1.1.7—The HFGs remain exposed to the radiation heat source inside the environmental chamber until a stable reading of 3.65±0.05 W/cm² (3.21±0.04 BTU/ft²·sec) is achieved (see Section 2.10 Stability).
6.1.1.8—If the heat flux is unacceptable, adjust the power and wait for the heat flux to re-stabilize (see section 4.2.1). Repeat this procedure until an acceptable heat flux level is obtained.

### 6.2 Heat Flux Uniformity Calibration (Corner Positions)

The uniformity of heat flux is determined by heat flux sensor measurements at each of the four corners of the specimen surface. The heat flux at each corner must be 3.65±0.1 W/cm² (3.21±0.09 BTU/ft²·sec). The heat flux uniformity checks should be carried out daily when testing and after each repair or maintenance of radiant heat source components. Some examples include (but are not limited to): the replacement of globars, wiring terminal connections, insulator devices, reflector plate, or diamond-shaped mask including mounting hardware. Additional examples include the repair or replacement of the globar power supply or its components, and recalibration of HFGs, data-acquisition system, and display devices.

### 6.2.1 Procedure

6.2.1.1—Conduct the heat flux calibration procedure (see section 6.1).
6.2.1.2—Once complete, start with any one of the four corner measurements and determine the heat flux level.
6.2.1.3—Open the inner radiation doors, return the HFG assembly to the holding chamber, and rotate 90°. Care must be taken during this step not to make contact with the upper pilot tube. Do not rotate the calibration assembly until it is fully withdrawn into the holding chamber. Ensure it has been rotated a full 90 degrees before reinserting it into the environmental chamber.
6.2.1.4—Reinsert the assembly back into the chamber and close the doors. Allow time to restabilize and record heat flux levels. Repeat this process for the remaining corners.
6.2.1.5—The heat flux at each corner must be 3.65±0.1 W/cm² (3.21±0.09 BTU/ft²·sec). Adjustments can be made to improve the heat flux uniformity by varying the power settings accordingly, repositioning the globars (in appearance) from hottest to coolest starting from the bottom position, moving the diamond-shaped mask closer to or farther from the center HFG (in and out), sliding the globars left or right, or by adjusting the reflector plate slope top and bottom as needed.
6.2.1.6—If adjustments were necessary during this procedure, the center heat flux should be rechecked before continuing.

In the preferred embodiment, testing does not include a baseline methane calibration procedure, as would be required under Title 14 of the Code of Federal Regulations.

### 7.0 Preparation/Test Procedure

### 7.1 Preparation

7.1.1—Clean the upper thermocouples (hot junctions of the thermopile) if necessary and check their position using a handheld template.
7.1.2—Remove any debris that may have settled on the second-stage air distribution plate.
7.1.3—Check the position of the injected sample holder with the pilot burners by using a positioning tool and an adjustable stop on the insertion mechanism.
7.1.4—Turn on the exhaust hood system.
7.1.5—Ensure correct airflow through the apparatus (see section 4.2.6).
7.1.6—Set the power supply to the globars to produce a total heat flux density of 3.65±0.05 W/cm² (3.21±0.04 BTU/ft²·sec). The thermopile baseline temperature must be carefully observed during daily testing. Changes in the baseline temperature can be an indicator of developing problems, such as variations in heat flux (HFG malfunction), defects in the thermopile, or air leakage in the environmental chamber/lower plenum, exhaust stack, or holding chamber door seal. Additionally, there is the possibility of the inlet airflow MFC not functioning properly. It is good practice to also monitor daily globar power control settings.
7.1.7—Turn on methane gas and mixing air to ensure correct supply pressure (see section 2.8).
7.1.8—Light the upper and lower pilot flames and check the gas flow and respective flame profile (see 4.2.3 and 4.2.4).
7.1.9—Close all doors.
7.1.10—Allow the system time to re-stabilize with burners lit for 10-15 minutes before testing.
7.1.11—Activate the spark igniter(s) if used.
7.1.12—Ensure the HSI is positioned correctly (see section 4.2.4.1).
7.1.13—Prepare the specimen for testing (see section 5.3).
7.1.14—If needed, attach the drip pan to the specimen holder (see Section 4.2.7.1).

### 7.2 Test Procedure

7.2.1—Ensure the radiation doors are closed.
7.2.2—Within approximately 10 seconds, open the holding chamber door, place the specimen holder on the mounting plate, close the door, and start the recording device.
7.2.3—Keep the specimen in the holding chamber for 60 seconds. Record, at least once a second, the thermopile temperature (Tₒᵤₜ−Tᵢₙ) during the final 20 seconds of the hold time before the specimen is injected and report the average as the baseline thermopile reading ΔT_{BL}(t) in ° C. and Kelvin. Caution must be used to ensure that the baseline reading is completed before opening the inner doors for sample injection.
7.2.4—After recording the baseline reading and within a timeframe not exceeding 5 seconds, open the radiation doors, inject the specimen into the environmental chamber, and close the doors. The 5-minute test starts when the sample stops its transition into the environmental chamber (inner radiation doors close immediately after). Record the thermopile temperature output at least once a second for the duration of the test.
7.2.5—Watch the burning process and record any observation of melting, sagging, dripping, delaminating, or other behavior that affected the exposed surface area or mode of burning and the time (in seconds) at which such behavior occurred.
7.2.6—Watch the pilot flames during the test. If the lower pilot burner was extinguished for a period longer than 3 seconds or at least 3 of the upper pilot flames were extinguished simultaneously for any period exceeding 3 seconds, mark this test run as invalid. The use of an externally positioned mirror or camera may assist in viewing upper pilot flames during testing.
7.2.7—After the test has been running for 5 minutes, open the radiation doors, return the specimen to the holding chamber, and close the radiation doors.
7.2.8—When ready to remove the sample, open the holding chamber door, remove the specimen holder from the mounting plate, and close the door. Caution must be exercised: hot and toxic gases could be present!
7.2.9—Clean the hot zone thermocouples with distilled water spray.

### 7.3 Preparation of Further Test Runs

Wait until the baseline temperature has re-stabilized before beginning another test. Depending on the construction of the material or its burning intensity, wait times may vary. For dripping materials or products that fall to the lower plate during testing, debris must be removed from the chamber before the next test.

Clean the upper thermocouples of soot after each test using a spray of distilled water. Ensure that the thermocouples are in their proper position before proceeding with the next specimen; a handheld template may be used to facilitate this step.

### 8.0 Determination of Kh₁ and Kh₂

An automatic calculation of the heat release rate (HRR) that is in agreement with HRR history, referred to as AutoCal, obviates methane calibration (discussed above) by using the temperature rise of the combustion stream in an empirical formula. In Equation 23 (below), Kh₁ is a calibration factor determined by sensible heat rise of the air stream though the apparatus 300 due to heating element power (globars) and pilot burner flame. The steady state, absolute temperature is recorded immediately prior to testing, as baseline temperature ΔT_{BL}(t) Kelvin, then factored into a convective heat transfer calculation. Calibration factor Kh₂ is calculated using the known heat content of methane gas and differential temperature rise ΔT(t) of the air stream due to material combustion. The sum of these two dynamic factors is divided by the average exhaust gas temperature Tₒᵤₜ(t) ° C. to calculate total Kh. Dividing ΔT(t) by the sample area then multiplying by Kh yields HRR values.

$$HRR ( \frac{k W}{{m}^{2}} ) = \frac{Δ T ( t )}{A} ( K h ) = \frac{Δ T ( t )}{A} ( K {h}_{1} + K {h}_{2} ) = \frac{Δ T ( t )}{A} ( \frac{{C}_{1}}{{T}_{o u t} ( t )} + \frac{{C}_{2}}{{T}_{o u t} ( t )} ) \qquad ( 23 )$$

In an application where there is a desire to increase or decrease the scale of AutoCalHRR, a decimal fraction scale factor (S_{f}) may be incorporated as,

$$HRR ( \frac{k W}{{m}^{2}} ) = \frac{Δ T ( t )}{A} ( Kh * {S}_{f} ) \qquad ( 24 )$$

For example, if desired to reduce AutoCal HRR by 10%, then,

$$HRR ( \frac{k W}{{m}^{2}} ) = \frac{Δ T ( t )}{A} ( Kh * {S}_{f} ) = \frac{Δ T ( t )}{A} ( Kh * 0.9 ) \qquad ( 25 )$$

8.1 Required recording parameters for AutoCal

### 8.1.1 Baseline ΔT_{BL}(t) ° C. and Kelvin

In the preferred embodiment, Baseline ΔT_{BL}(t) ° C. is determined by first subtracting the inlet air temperature (Tᵢₙ) from the average of five exhaust gas temperature thermocouples (Tour) to calculate the instantaneous differential thermopile reading T(t). A specimen is then placed in the holding chamber for a period of 60 seconds prior to testing. At least once a second, the thermopile temperature T(t) is recorded during the final 20 seconds of the hold time before the specimen is injected into the environmental chamber and the average as the baseline thermopile reading ΔT_{BL}(t) in ° C. and Kelvin is reported.

$$Real - time thermopile Δ T ( t ) = T ( t ) - Δ {T}_{B L} ( t ) ° C .$$

Real-time average exhaust gas temperature Tₒᵤₜ(t) ° C. Note: The formula to convert Celsius to Kelvin is T(K)=T(C)+273.15.

$$Determining Calibration Factor {Kh}_{1} = {c}_{1} / {T}_{out} ( t )$$

Calculating C₁ and Tₒᵤₜ(t):

$${C}_{1} = {( {h}_{c} )}_{a i r} Δ {T}_{B L} ( t ) + {( {h}_{s} )}_{a i r} = ( 11.4 W / K ) Δ {T}_{B L} ( t ) + 3113 W \qquad ( 24 )$$

Solving (h_{c})ₐᵢᵣ:

$${( {h}_{c} )}_{a i r} = Sensible heat of combustion constant = cp * ρ * q$$

where

$$cp = specific heat of air ( 1006 J / kg K )$$

$$ρ = density of air ( 1.2 kg / {m}^{3} )$$

$$q = air volume flow ( 0.00944 {m}^{3} / s )$$

$$= ( 1006 J / kg K ) ( 1.2 kg / {m}^{3} ) ( 0.00944 {m}^{3} / s )$$

$$= 11.4 W / K$$

### Solving ΔT_{BL}(t) Kelvin:

$$Δ {T}_{BL} ( t ) = 20 second average , pre - test , baseline thermopile temperature$$

Solving (hₛ)ₐᵢᵣ:

$${( {h}_{s} )}_{a i r} = Convective heat transfer compensation = cp * ρ * q * Δ T ( K )$$

where

$$cp = specific heat of air ( 1006 J / kg K )$$

$$ρ = density of air ( 1.2 kg / {m}^{3} )$$

$$q = air volume flow ( 0.00944 {m}^{3} / s )$$

$$Δ T = 273.15 K ( 0 ° C . )$$

$$= ( 1006 J / kg K ) ( 1.2 kg / m \hat{} 3 ) ( 0.00944 m \hat{} 3 / s ) ( 273.15 K )$$

$$= 3113 W$$

### Solving Tₒᵤₜ(t) ° C.:

$${T}_{out} ( t ) = Real - time , average , thermopile exhaust gas temperature$$

$$Determining Calibration Factor {Kh}_{2} = \frac{{C}_{2}}{{T}_{out} ( t )}$$

Calculating C₂ and Tₒᵤₜ(t):

$${C}_{2} = \frac{{\dot{Q}}_{{CH}_{4}}}{Δ {T}_{{CH}_{4}}} Δ T ( t ) = \frac{{( {H}_{c} ρ q )}_{{CH}_{4}}}{Δ {T}_{{CH}_{4}}} Δ T ( t ) = \frac{597 W}{23.23} Δ T ( t ) = ( 25.7 W / K ) Δ T ( t ) \qquad ( 25 )$$

Solving \dot{Q}_{CH}_{₄}:

$${\dot{Q}}_{{CH}_{4}} = {H}_{c} * ρ * q$$

where

$${H}_{c} = Net heat of complete combustion of methane = 50.03 MJ / kg$$

$$ρ = Methane density at STP = 0.714 kg / {m}^{3}$$

$$q = Volumetric methane calibration flow rate , = 1.67 \times {10}^{- 5} {m}^{3} / s ( 1 slmp )$$

$$= ( 50.03 MJ / kg ) ( 0.714 kg / {m}^{3} ) ( 1.67 \times {10}^{- 5} {m}^{3} / s )$$

$$= 597 W$$

### 8.3.1.2 Solving ΔT_{CH}_{₄}:

$$Δ {T}_{{CH}_{4}} = \frac{HRR}{{K}_{h} / sample area}$$

where

$$Sample area ( A ) = 0.0 \; 2323 {m}^{2}$$

$$HRR = \frac{{\dot{Q}}_{{CH}_{4}} ( W )}{sample area ( {m}^{2} )} = \frac{597 W}{0.0 \; 2323 {m}^{2}} = 25.7 \frac{k W}{{m}^{2}}$$

$${K}_{h} = 25.7 \frac{W}{K}$$

$$= \frac{25.7 \frac{k W}{{m}^{2}}}{( 25.7 W / K ) / ( 0.0 \; 2323 {m}^{2} )}$$

$$= 23.23 K$$

### 8.3.1.3 Solving ΔT(t) ° C.:

$$Δ T ( t ) = Real - time , average , thermopile temperature minus baseline thermopile temperature$$

### 8.3.1.4 Solving Tₒᵤₜ(t) ° C.

$${T}_{out} ( t ) = Real - time , average , thermopile exhaust gas temperature$$

### 9. Presentation of Results

For all specimens tested, the maximum heat release rate should be determined and recorded during a 5-minute test. Also, the total heat release should be computed and recorded during the first 2 minutes of testing by integrating the heat release rate over time. When calculating the total heat release, only positive heat release rate values are included in the summation.

### 9.1 Heat Release Rate

At a data-collection frequency of 1 Hz or 1 scan per second, the heat release rate is calculated for any point in time during a test from the reading of the thermopile temperature output at that time (see Section 3.6).

9.1 Total Heat Release (2-minute)

In Equation 17, the total heat release (kW·min/m²) as a function of time (in minutes) based on the integral of the heat release rate can be determined,

$$Total Heat Release = \frac{{\sum }_{t = 0}^{n - 1} ( HRR )}{x} kW \cdot min / {m}^{2} \qquad ( 26 )$$

Where:
n=Total number of data collection points in 2 minutes.
x=Total number of data collection points in 1 minute.
NOTE: This formula uses the Riemann Left-Hand Sum method of integration (t=0).

### 10. Accuracy, Units, and Rounding

For this test method, all values are rounded up (see Table 1). If the next place beyond where a digit is terminated is greater than or equal to 5, the terminating digit is increased by a value of 1, and the digits to the right are dropped off (e.g., 25.476 accurate to the hundredths place is rounded up to 25.48). Unless otherwise stated, Table A should apply.

TABLE 1
Accuracy, Units, and Rounding

| Accuracy | Description | Units |
|---|---|---|
| Tenths place | Peak heat release rate | kW/m² |
| (e.g., x.x) | Time to peak | Sec |
| | 2-minute total heat release | kW · min/m² |
| | Heat release rate | kW/m² |
| | Temperature | ° F./° C./K |
| | Relative humidity | % RH |
| Hundredths place | Heat flux | W/cm² |
| (e.g., x.xx) | Airflow | SCFM |
| | Methane gas flow | SLPM |
| | % Standard deviation | % |
| Hundred-thousandths | Sample area | m² |
| place (e.g., x.xxxxx) | | |

### 11. Requirements

A minimum of three samples should be tested, and 80% or greater must pass criteria for Peak Heat Release Rate and Total Heat Release.

Peak Heat Release Rate (kW/m²): The maximum heat release rate during the 5-minute test will not exceed 65 kW/m².

Initial 2-Minute Total Heat Release (kW·min/m²): The total heat released during the first 2 minutes should not exceed 65 kW·min/m².

Nominal Operating Ranges are provided in Table 2 below.

### 12. Test Report

The test report should include the following:
Identify the material tested.
Graphically report the heat release rate (kW/m²) at 1 hertz (Hz) as a function of time (in seconds) for each test.
Report the maximum heat release rate and time (in seconds) it occurs during each test.
Report the total heat released during the first 2 minutes of each test.
Report the radiant heat flux to the specimen.
Report the average baseline temperature for each specimen tested.
Report any melting, sagging, dripping, delaminating, or other behavior that affected the exposed surface area or mode of burning that occurred and the time (in seconds) at which such behavior occurred.
Report the total number of materials tested and the total number of materials that passed.

TABLE 2
Nominal Operating Parameters/Ranges

| PARAMETER | DESCRIPTION | MIN. | NOMINAL. | MAX. |
|---|---|---|---|---|
| Inlet Airflow Rate | SCFM | 19.6 | 20 | 20.4 |
| Inlet Air Temperature | ° C. | 21.1 | 22.5 | 23.9 |
| Inlet Air Relative Humidity | % RH | — | — | ≤65 |
| Heat Flux (W/cm²) | Center | 3.60 | 3.65 | 3.70 |
| | Each Corner (4) | 3.55 | 3.65 | 3.75 |
| Average Baseline Exhaust Gas | No Flame (° C.) | 275 | 285 | 295 |
| Temperature | | | | |
| Interspace Pressure | inH2O | 0.40 | 0.55 | 0.70 |
| Lower Plenum Pressure | inH2O | 12.0 | 12.5 | 13.0 |
| Methane Gas Supply Pressure | PSIG | 20 | 25 | 30 |
| Main Air Supply Pressure | PSIG | 20 | 25 | 30 |
| Mixing Air Supply Pressure | PSIG | 20 | 25 | 30 |
| Specimen Conditioning | Temperature (° C.) | 18 | 21 | 24 |
| | Relative Humidity (%) | 45 | 55 | 65 |
| Upper Pilot Gas Flow | Air (SLPM) | 0.98 | 1.00 | 1.02 |
| | Methane (SLPM) | 1.47 | 1.50 | 1.53 |
| Lower Pilot Gas Flow | Air (mL/min) | 650 | 700 | 750 |
| | Methane (mL/min) | 105 | 120 | 135 |

NOTE:
When not a requirement, the values in Table 2 may be used as a guide for overall system performance. Not all parameters listed are absolute or required but may help identify underlying problems that may be present.

### 13 Test Data

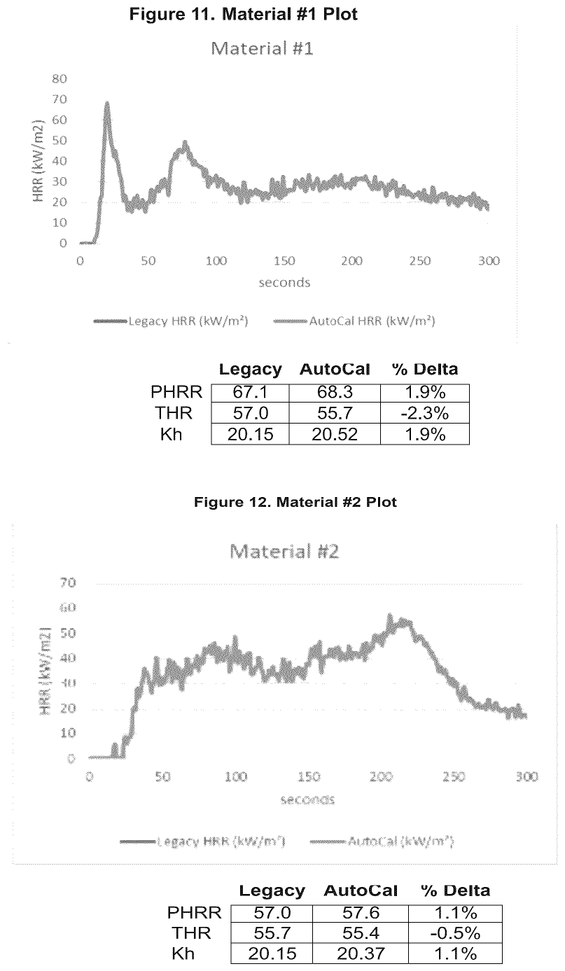

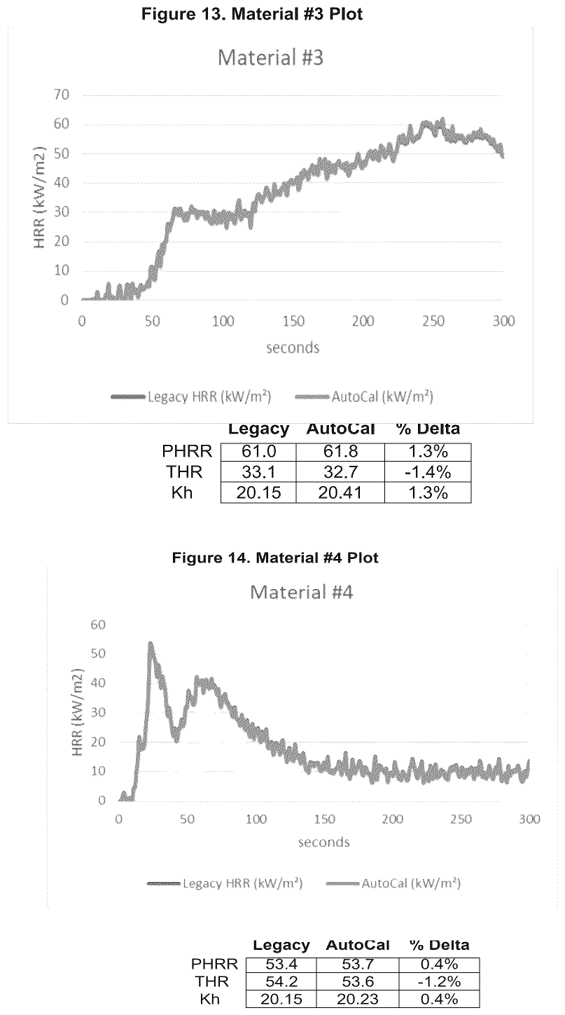

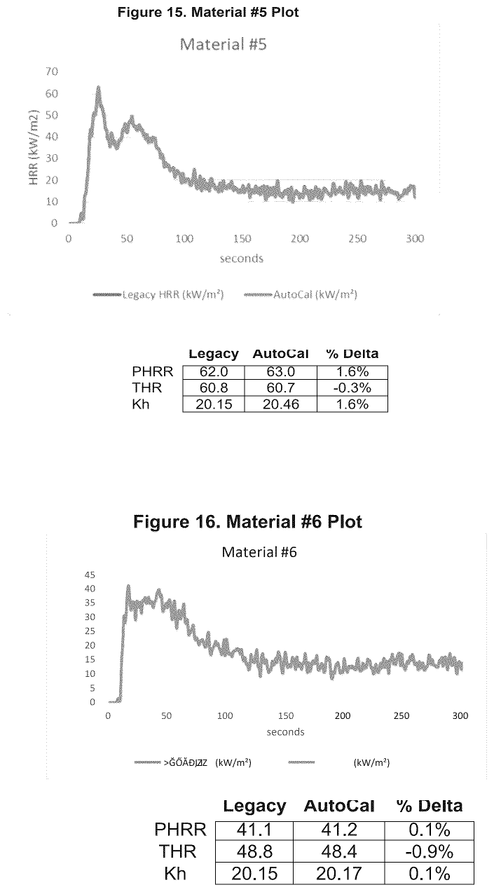

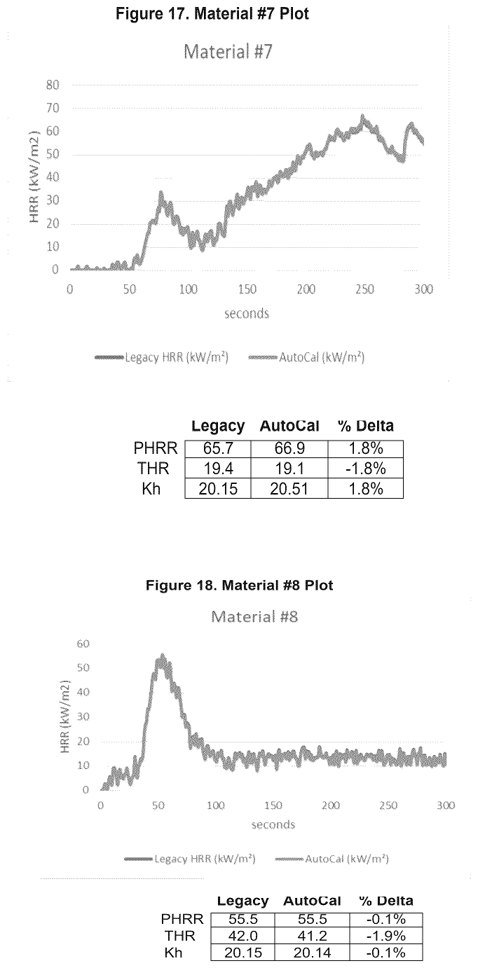

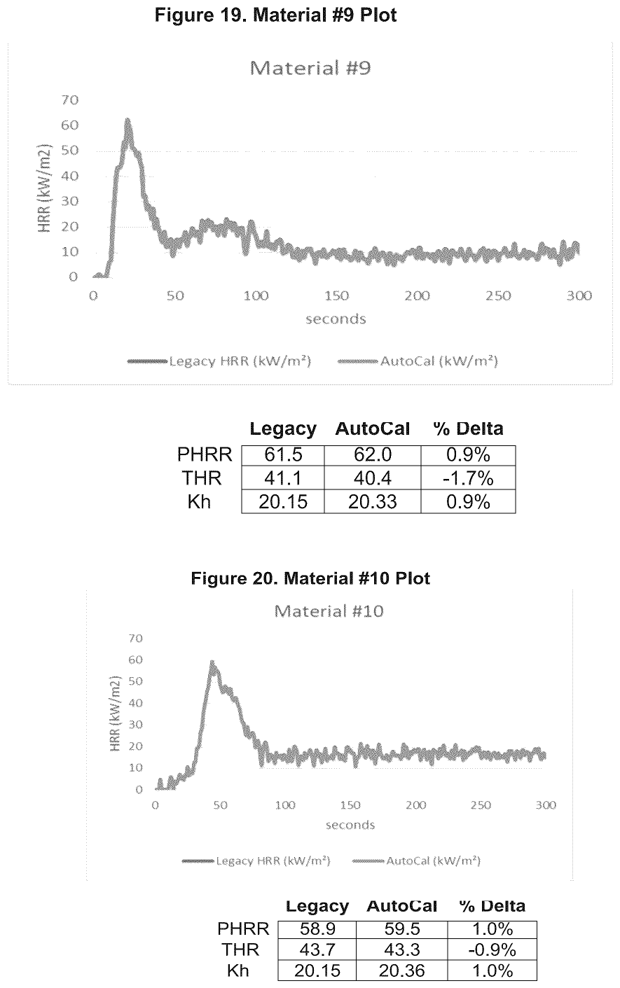

The data in the plots of FIGS. 10-20 illustrate comparative test results using AutoCal to calculate HRR and the legacy FAA calibration method. As can be seen, the AutoCal method calculations follow closely those determinations using the legacy FAA method, without the need to calibrate the system using methane calibration, as discussed above. Specifically, the difference in most instances did not exceed 2.0%.

### 14. Data Collection System

As discussed above, the digital data collection system 500 is operably coupled to the heat release rate apparatus 300 for the recording of the output from the mass flow controllers, heat flux gauges, and thermocouples, as the case may be. The data collection system should have an accuracy corresponding to at least 0.5° C. for the temperature measuring channels, and 0.01% of full-scale instrument output for all other instrument channels. The system should be capable of recording data at intervals of once per second (1 hertz).

In addition to data collecting, the system 500 preferably also includes programming that when executed causes the system to store the data collected in one or more databases, and to process the data, as discussed herein, including with regard to calculating the HRR of materials using the novel AutoCal approach of the present application, or any variable or constants used therein based on the data collection. In certain embodiments, the variables and/or constants are determined based on historic data collections. In this regard, the system may be configured to store and/or retrieve historic data for the apparatus obtained using legacy systems (calibrated using methane) and to calculate variables and/or constants using the AutoCal method based on the historic data. The system may then use AutoCal variables and/or constants to calculate HRR without the need for methane calibration. The system may include a controller configured to control the various inputs and/or outputs of the heat release apparatus 300 based on the inputs, such as variable radiation source power, pilot and burner gas pressure and/or flow, ignitor ignition, air distribution system air flow and/or pressure, HFG cooling water temperature, pressure and flow, MFC gas pressure and/or temperature, methane and air mixing, and the various temperature(s) and pressure(s) discussed herein.

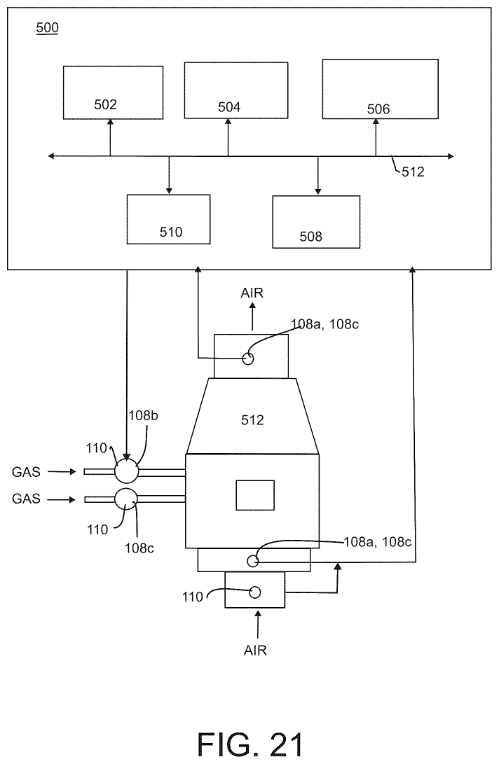

FIG. 21 is an architectural block diagram of an exemplary data acquisition system. The system may include a computing device 500 that may be used in conjunction with the disclosed embodiments of the heat release rate apparatus 300. In one embodiment, the computing device 500 is operatively coupled to one or a plurality of sensors 108, such as (thermocouple) temperature 108a, pressure 108b, and air/gas flow 108c sensors. As discussed herein, the system is generally configured to capture the physical and/or operating parameters within the heat release apparatus 300 using the sensors 108. The physical parameters are uploaded to the computing device 500 for processing, as discussed herein. As also discussed herein, the system may be configured to control the various inputs and outputs to/from the heat release apparatus. The computing device 500 may therefore be further operably connected to one or more control devices 110, gas and/or air flow/pressure control devices, etc.

In one embodiment, computing device 500 may be a personal computer, a workstation, server computer, special purpose computer, etc. As shown, the computing device 500 may include a processor 502, a memory 504, storage 506, I/0 interface 508, a communication interface 510, and internal bus architecture 512. Processor 102 may be a general-purpose microprocessor (e.g., a central processing unit (CPU), a graphics processing unit (GPU), a microcontroller, a microprocessor, a digital signal processor (DSP), an application specific integrated circuit (ASIC), a field programmable gate array (FPGA), a programmable logic device (PLO), a controller, a state machine, gated or transistor logic, discrete hardware components, or any other suitable entity or combinations thereof that is configured to perform calculations, process instructions for execution, and/or other manipulations of information as discussed herein. In some implementations, processor 102 includes one or more multiple processors capable of being programmed to perform a function; for example, processor 502 may be programmed to receive and process data and information from, and/or provide data and information to, any or all of the components of the heat release apparatus. Processor 502 may be implemented in hardware, firmware, or a combination of hardware and software.

Memory 104 may include read only memory (ROM), cache, random access memory (RAM), and/or another type of dynamic or static storage (e.g., a flash memory, a magnetic memory, and/or an optical memory) that stores information and/or instructions for use by processor 502. In one embodiment, memory 504 is configured to store programmable software. Storage 506 stores information and/or software related to the operation and use of computing device 500 and may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The I/0 interface 508 allows a user to provide input to, receive output from, and otherwise transfer data to and receive data from computing device 500. The I/0 interface 508 may include a mouse, a keypad or a keyboard, a touchscreen, a camera, an optical scanner, network interface, modem, other known I/0 devices or a combination of such I/0 interfaces. The I/0 interface 508 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/0 interface 508 is configured to provide graphical data to a display for presentation to a user. The graphical data may be representative of one or more graphical user interfaces and/or any other graphical content as may serve a particular implementation.

Communication interface 510 includes a transceiver and/or a separate receiver and transmitter and may be implemented via a wired connection, a wireless connection, or a combination of wired and wireless connections, including an Ethernet interface, an optical interface, a coaxial interface, an infrared interface, a radio frequency (RF) interface, a universal serial bus (USB) interface, a Wi-Fi interface, a wireless network interface, or the like. Communication interface 510 enables computing device 500 to communicate with other devices, to receive data and information from and/or to provide data and information to any or all of the components of the embodiments of the present invention.

Internal bus architecture 512 may include hardware, software, or both that communicatively couples the components of the computing device 500 to each other and may include data buses, address buses, and control buses. As an example and not by way of limitation, internal bus architecture 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an IN FI NI BAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

Computing device 500 may perform one or more processes described herein and may perform these processes based on processor 502 executing software instructions stored by a non-transitory computer readable medium, such as memory 504 and/or storage 506. Software instructions may be read into memory 504 and/or storage 506 from another computer-readable medium or from another device via communication interface 510. When executed, software instructions stored in memory 504 and/or storage 506 may cause processor 502 to perform one or more processes described herein. Additionally, or alternatively, hardwired circuitry may be used in place of or in combination with software instructions to perform one or more processes described herein. Thus, implementations described herein are not limited to any specific combination of hardware circuitry and software. The number and arrangement of components shown in the companying figures are provided exemplary only. Computing device 500 may include additional components, fewer components, different components, or differently arranged components than those shown. Additionally, or alternatively, a set of components (e.g., one or more components) of computing device 500 may perform one or more functions described as being performed by another set of components of computing device 500.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A system for determining the heat release rate of a sample material, the system comprising a computing device coupled to a heat release rate apparatus, the heat release rate apparatus comprising:
an environmental chamber having a tubular structure with openings at a top end and a bottom end thereof, the environmental chamber comprising a plurality of heating elements that provide heat flux directed at the sample material, and an upper pilot burner and a lower pilot burner, wherein the lower pilot burner initiates combustion of the sample material and the upper burner ignites off-gassing products during testing of the sample material;
a holding chamber having a tubular structure with openings laterally at a distal end and a proximal end thereof, the holding chamber tangentially coupled to the environmental chamber with a radiation door assembly between the environmental chamber and the holding chamber;
a pyramidal section having openings at a top end and a bottom end thereof, the bottom end of the pyramidal section coupled to the top end of the environmental chamber; and
a plurality of sensors comprising a set of first temperature sensors located at the outlet end of the pyramidal section for measuring exit gas temperature and a second temperature sensor for measuring inlet air temperature,
wherein the computing device is configured to receive temperature readings from the plurality of sensors, including the exit gas temperature and the inlet air temperature, and to determine the heat release rate (HRR) of the sample material based on absolute temperature differential of a combustion stream through the apparatus.

2. The system of claim 1, wherein the pyramidal section has a single plenum structure without supplemental cooling.

3. The system of claim 1, wherein the set of first temperature sensors comprise a plurality of thermocouples configured to continuously monitor exit gas temperature.

4. The system of claim 3, wherein the plurality of thermocouples comprise at least five thermocouples with ends located below the outlet opening of the pyramidal section, including a first thermocouple with an end placed at a geometric center of the outlet opening, and four other thermocouples with ends placed at the outlet opening radially from the first thermocouple end.

5. The system of claim 4, the ends of the first and the four other thermocouples are placed along a single horizontal plane within the outlet opening of the pyramidal section.

6. The system of claim 4, wherein the first and the four other thermocouples each have an outer portion that extends horizontally and is parallel to the outer portion of the other thermocouples.

7. The system of claim 6, wherein the first and the four other thermocouples comprise a first pair and second pair of thermocouples that each have a thermocouple that is a mirror image of the other thermocouple.

8. The system of claim 4, wherein the absolute temperature differential of the combustion stream through the apparatus is determined based on an average of inputs from the first and the four other thermocouples at the outlet temperature determined, and inputs from the second temperature sensor.

9. The system of claim 1, the apparatus comprising a mass airflow controller that controls airflow through the apparatus to 20.0±0.4 SCFM at 22.5±1.4° C., the mass airflow controller located at an inlet of the environmental chamber.

10. The system of claim 1, the apparatus comprising first and second stage distribution plates each having a plurality of holes therein to provide laminar flow within at least a portion of the environmental chamber.

11. The system of claim 1, the apparatus comprising a specimen rod configured to receive the sample material at a distal end of the specimen rod, the specimen rod slidingly attached to a holding chamber door that is hingedly coupled to the holding chamber at the proximal opening of the holding chamber, the specimen rod therewith configured to insert the sample specimen into the holding chamber in an arcuate trajectory and then into the environmental chamber by sliding the specimen rod distally through the radiation door assembly toward the environmental chamber.

12. The system of claim 1, wherein the heating elements provide heat flux directed at the sample material center at 3.65±0.05 W/cm².

13. The system of claim 1, wherein the computing device determines HRR based on a baseline temperature differential before the sample material is inserted into the environmental chamber, and the absolute temperature differential after the sample material is inserted into the environmental chamber.

14. The system of claim 13, wherein the computing device determines HRR based on a first calibration factor (Kh₁) determined by sensible heat rise of the air stream though the apparatus, and a second calibration factor Kh₂ calculated using known heat content of methane gas and differential temperature rise ΔT(t) of the air stream due to material combustion.

15. The system of claim 13, wherein the computing device determines HRR based on the following formula:
$$HRR ( \frac{kW}{{m}^{2}} ) = \frac{Δ T ( t )}{A} ( Kh ) = \frac{Δ T ( t )}{A} ( {Kh}_{1} + {Kh}_{2} ) = \frac{Δ T ( t )}{A} ( \frac{{C}_{1}}{{T}_{out} ( t )} + \frac{{C}_{2}}{{T}_{out} ( t )} )$$
$$where {Kh}_{1} = \frac{{C}_{1}}{{T}_{out} ( t )} and {Kh}_{2} = \frac{{C}_{2}}{{T}_{out} ( t )} , and$$
$$where {C}_{1} = {( {h}_{c} )}_{air} Δ {T}_{BL} ( t ) + {( {h}_{s} )}_{air} and {C}_{2} = \frac{{\dot{Q}}_{{CH}_{4}}}{Δ {T}_{{CH}_{4}}} Δ T ( t ) .$$

16. A system for determining the heat release rate of a sample material, the system comprising a computing device coupled to a heat release rate apparatus, the heat release rate apparatus comprising:
an environmental chamber having a tubular structure with openings at a top end and a bottom end thereof, the environmental chamber comprising a plurality of heating elements that provide heat flux directed at the sample material, and an upper pilot burner and a lower pilot burner, wherein the lower pilot burner initiates combustion of the sample material and the upper burner ignites off-gassing products during testing of the sample material,
the environmental chamber comprising first and second stage distribution plates each having a plurality of holes therein to provide laminar flow within at least a portion of the environmental chamber;
a holding chamber having a tubular structure with openings laterally at a distal end and a proximal end thereof, the holding chamber tangentially coupled to the environmental chamber with a radiation door assembly between the environmental chamber and the holding chamber;
a single plenum pyramidal section having openings at a top end and a bottom end thereof, the bottom end of the pyramidal section coupled to the top end of the environmental chamber; and
a plurality of sensors comprising a set of first temperature sensors located at the outlet opening of the pyramidal section for measuring exit gas temperature and a second temperature sensor for measuring inlet air temperature,
wherein the set of first temperature sensors comprise a plurality of thermocouples configured to continuously monitor exit gas temperature, and
wherein the plurality of thermocouples comprise at least five thermocouples with ends located below the outlet opening of the pyramidal section, including a first thermocouple with an end placed at a geometric center of the outlet opening, and four other thermocouples with ends placed at the outlet opening radially from the first thermocouple end and along a single horizontal plane within the outlet of the pyramidal section;
wherein the computing device is configured to receive temperature readings from the plurality of sensors, including the exit gas temperature and the inlet air temperature, and to determine the heat release rate (HRR) of the sample material based on absolute temperature differential of a combustion stream through the apparatus, determined based on an average of inputs from the first and the four other thermocouples at the outlet temperature determined, and inputs from the second temperature sensor.

17. The system of claim 16, wherein the first and the four other thermocouples comprise a first pair and second pair of thermocouples that each have a thermocouple that is a mirror image of the other thermocouple.

18. The system of claim 16, the apparatus comprising a mass airflow controller that controls airflow through the apparatus to 20.0±0.4 SCFM at 22.5±1.4° C., the mass airflow controller located at an inlet of the environmental chamber, and wherein the heating elements provide heat flux directed at the sample material center at 3.65±0.05 W/cm².

19. The system of claim 16, the apparatus comprising a specimen rod configured to receive the sample material at a distal end of the specimen rod, the specimen rod slidingly attached to a holding chamber door hingedly coupled to the holding chamber at the proximal opening of the holding chamber, the specimen rod therewith configured to insert the sample specimen into the holding chamber in an arcuate trajectory and then into the environmental chamber by sliding the specimen rod distally through the radiation door assembly toward the environmental chamber.

20. The system of claim 16, wherein the computing device determines HRR based on the following formula:
$$HRR ( \frac{kW}{{m}^{2}} ) = \frac{Δ T ( t )}{A} ( Kh ) = \frac{Δ T ( t )}{A} ( {Kh}_{1} + {Kh}_{2} ) = \frac{Δ T ( t )}{A} ( \frac{{C}_{1}}{{T}_{out} ( t )} + \frac{{C}_{2}}{{T}_{out} ( t )} )$$
$$where {Kh}_{1} = \frac{{C}_{1}}{{T}_{out} ( t )} and {Kh}_{2} = \frac{{C}_{2}}{{T}_{out} ( t )} , and$$
$$where {C}_{1} = {( {h}_{c} )}_{air} Δ {T}_{BL} ( t ) + {( {h}_{s} )}_{air} and {C}_{2} = \frac{{\dot{Q}}_{{CH}_{4}}}{Δ {T}_{{CH}_{4}}} Δ T ( t ) .$$
While the foregoing invention has been described in some detail for purposes of clarity and understanding, it will be appreciated by one skilled in the art, from a reading of the disclosure, that various changes in form and detail can be made without departing from the true scope of the invention.
